(19) United States
(12) Patent Application Publication
(10) Pub. No.: US 2016/0366229 A1
(43) Pub. Date: Dec. 15, 2016

(54) COMMUNICATION DEVICE, COMMUNICATION SYSTEM, AND COMPUTER PROGRAM PRODUCT

(71) Applicant: Kabushiki Kaisha Toshiba, Minato-ku (JP)

(72) Inventors: Takahiro YAMAURA, Kawasaki (JP); Takeshi ISHIHARA, Yokohama (JP)

(73) Assignee: Kabushiki Kaisha Toshiba, Minato-ku (JP)

(21) Appl. No.: 15/155,321

(22) Filed: May 16, 2016

(30) Foreign Application Priority Data
Jun. 9, 2015 (JP) 2015-116827

(51) Int. Cl. H04L 29/08; H04L 29/06

(52) U.S. Cl. CPC H04L 67/146; H04L 67/10; H04L 67/42; H04L 63/0876

(57) ABSTRACT

According to an embodiment, a communication device that connects a terminal device with a server device includes a receiver, an execution controller, and a setter. The receiver is configured to receive, from the server device, identification information for identifying a wireless network and program information for executing a program that performs wireless communication with the terminal device. The execution controller is configured to execute the program based on the program information. The setter is configured to set the wireless network so that the program performs communication with the terminal device using the wireless network identified by the identification information.

### CROSS-REFERENCE TO RELATED APPLICATION

This application is based upon and claims the benefit of priority from Japanese Patent Application No. 2015-116827, filed on Jun. 9, 2015; the entire contents of which are incorporated herein by reference.

### FIELD

Embodiments described herein relate generally to a communication device, a communication system, a communication method, and a computer program product.

### BACKGROUND

A data delivery system in which a plurality of roadside units installed in an area where vehicles stop or an area where vehicles reduce the speed receive a transmission agent (an update program executed by the roadside unit) transmitted from a delivery device, and wirelessly transmit a partial code (firmware) when vehicles enter a range in which communication can be performed has been known.

An authentication scheme or a delivery file format is considered to differ according to each manufacturer or a vehicle type, but a difference in the authentication scheme or the delivery file format has not been taken into account in a related art. Further, it is desirable that a network is separated as a delivery platform in terms of security.

### BRIEF DESCRIPTION OF THE DRAWINGS

FIG. 1 is an overall configuration diagram of a communication system according to the present embodiment;

FIG. 2 is a diagram illustrating an exemplary program that is activated on an AP;

FIG. 3A is a diagram illustrating an exemplary virtualization method;

FIG. 3B is a diagram illustrating an exemplary virtualization method;

FIG. 3C is a diagram illustrating an exemplary virtualization method;

FIG. 3D is a diagram illustrating an exemplary virtualization method;

FIG. 4 is a diagram illustrating a hardware configuration of a server;

FIG. 5 is a block diagram illustrating an exemplary functional configuration of a server;

FIG. 6 is a diagram for describing a data delivery method;

FIG. 7 is a diagram illustrating a hardware configuration of an AP;

FIG. 8 is a block diagram illustrating an exemplary functional configuration of an AP;

FIG. 9 is a diagram illustrating an exemplary configuration of a virtual network in an AP;

FIG. 10 is a block diagram illustrating an exemplary detailed functional configuration of an executor;

FIG. 11 is a diagram illustrating a hardware configuration of a vehicle;

FIG. 12 is a block diagram illustrating an exemplary functional configuration of a vehicle;

FIG. 13 is a sequence diagram illustrating an exemplary overall flow of a delivery process;

FIG. 14 is a diagram illustrating an exemplary data structure of approach information;

FIG. 15 is a flowchart illustrating a process when approach information is transmitted from a vehicle;

FIG. 16 is a flowchart illustrating a process of activating a guest OS;

FIG. 17 is a flowchart illustrating a process of a delivery application;

FIG. 18 is a flowchart illustrating a process when data acquisition is requested;

FIG. 19 is a flowchart illustrating a process when data uploading is requested;

FIG. 20 is a flowchart illustrating a process when an update state notification is received;

FIG. 21 is a flowchart illustrating a process when a guest OS stop instruction is received;

FIG. 22 is a flowchart illustrating processes executed by a vehicle;

FIG. 23 is a flowchart illustrating a delivery data download process;

FIG. 24 is a flowchart illustrating an exemplary delivery data upload process;

FIG. 25 is a flowchart illustrating an exemplary update process;

FIG. 26 is a flowchart illustrating a process when a data acquisition status is requested;

FIG. 27 is a diagram for describing a method of selecting an acquisition destination without using route information;

FIG. 28 is a diagram for describing a method of selecting an acquisition destination without using route information;

FIG. 29 is a diagram for describing a method of selecting an acquisition destination using route information;

FIG. 30 is a diagram illustrating exemplary information that is transmitted and received through an authentication scheme and an authentication process;

FIG. 31 is a block diagram illustrating a functional configuration of an AP according to a modified example;

FIG. 32 is a diagram illustrating an exemplary data structure of connection information;

FIG. 33 is a diagram illustrating an exemplary data structure of execution information; and

FIG. 34 is a diagram illustrating an exemplary data structure of a data acquisition list.

### DETAILED DESCRIPTION

According to an embodiment, a communication device that connects a terminal device with a server device includes a receiver, an execution controller, and a setter. The receiver is configured to receive, from the server device, identification information for identifying a wireless network and program information for executing a program that performs wireless communication with the terminal device. The execution controller is configured to execute the program based on the program information. The setter is configured to set the wireless network so that the program performs communication with the terminal device using the wireless network identified by the identification information.

Hereinafter, exemplary embodiments of a communication device, a communication system, a communication method, and a program according to the invention will be described in detail.

A communication device according to the present embodiment sets a wireless network so that a program that delivers data (for example, firmware) to a terminal device (for example, a vehicle) performs communication with the terminal device using the wireless network. For example, at least one of the program and a wireless network interface (I/F) is divided into a plurality of pieces by virtualization. An improvement in security can be implemented by separation of the network I/F. Further, when the program is used according to a type of terminal device or the like, it is possible to deal with an authentication scheme and a delivery file format that differ according to a type or the like.

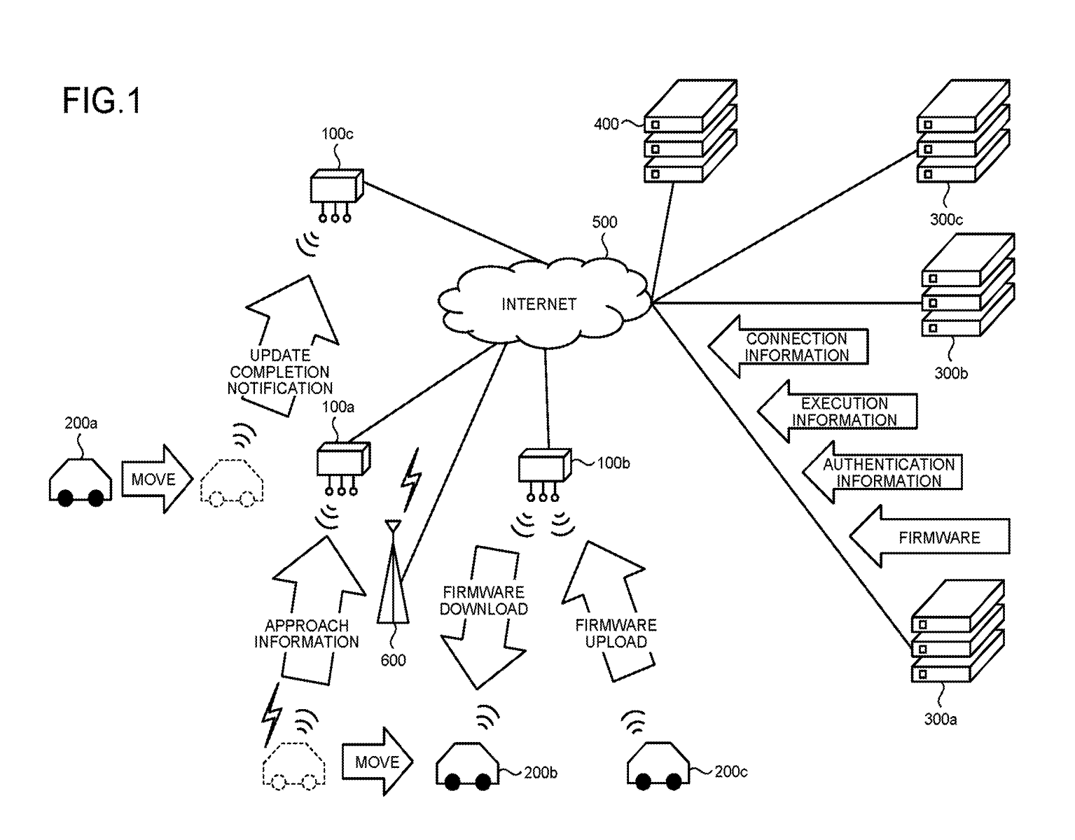

FIG. 1 is a diagram illustrating an exemplary overall configuration of a communication system according to the present embodiment. The communication system includes access points (APs) 100a, 100b, and 100c serving as a communication device, vehicles 200a, 200b, and 200c serving as a terminal device, servers 300a, 300b, and 300c serving as a server device, and a server 400 as illustrated in FIG. 1.

The AP 100, the server 300, and the server 400 are connected to one another, for example, via an Internet 500. The devices may be connected via a network other than the Internet. The AP 100 is connected with the vehicle 200 via a wireless network.

The APs 100a, 100b, and 100c have the same configuration and are referred to simply as an “AP 100” when the APs need not be distinguished from each other. Similarly, the vehicles 200a, 200b, and 200c are also referred to simply as a “vehicle 200”, and the servers 300a, 300b, and 300c are also referred to simply as a “server 300”. The number of APs 100, the number of vehicles 200, and the number of servers 300 are not limited to 3 and may be set to an arbitrary number.

The AP 100 is a communication device that performs wireless communication with the vehicle 200. For example, the AP 100 may be implemented as a roadside unit (an ITS spot) installed, for example, an end portion of a road on which the vehicle 200 travels.

The server 300 stores information used when the vehicle 200 and the AP 100 perform wireless communication, and transmits the information to the AP 100 as necessary. For example, the server 300 may be installed for each manufacturer of the vehicle 200. For example, the servers 300a, 300b, and 300c may be set as server devices corresponding to A, B, and C companies.

The server 400 is a server device that manages information such as position information of each AP 100 and an execution state of a program executed by the AP 100.

An overview of a data (firmware) delivery process performed by the communication system of the present embodiment will be described below with reference to FIG. 1. In FIG. 1, the vehicle 200b is assumed not to have updated firmware yet.

The vehicle 200b transmits approach information to the AP 100a which the vehicle 200b approaches while moving. The approach information may be transmitted via a cellular network through a base station 600 of the cellular network. The details of the approach information will be described later. The AP 100a transmits the approach information to the server 300. The server 300 specifies the AP 100 which the vehicle 200b is likely to communicate while moving with reference to the approach information or the like, and transmits information (connection information) necessary for a connection between the vehicle 200b and the specified AP 100 (the AP 100b in this example) to the vehicle 200b via the AP 100a or the base station 600 of the cellular network. The server 300 transmits information (execution information, authentication information, and firmware) necessary for delivery of firmware to the specified AP 100 (the AP 100b in this example). The details of each information will be described later.

When the vehicle 200b approaches within a distance at which wireless communication with the AP 100b is possible, the vehicle 200b downloads the firmware from the AP 100b. Part of the firmware may be downloaded from one AP 100. The AP 100b may receive the firmware from another vehicle (the vehicle 200c in this example) that has downloaded and updated the firmware already.

After the entire firmware is completely downloaded, a verification process or the like is executed, and then updating of the firmware is executed according to a designated schedule. For example, the vehicle 200 verifies a digital signature of the firmware, then sets an update schedule, and executes the updating at a scheduled update time when an ignition key is in an off state.

The vehicle 200 that has completed the updating transmits an update completion notification indicating that the updating has been completed to, for example, the server 400 through the AP 100. FIG. 1 illustrates an example in which the vehicle 200a transmits the update completion notification through the AP 100c.

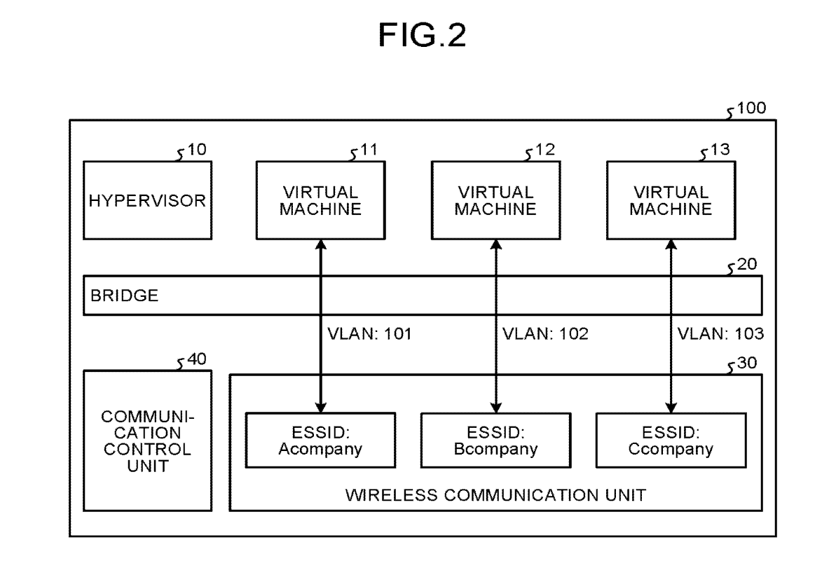

FIG. 2 is a diagram illustrating an exemplary program that is activated on the AP 100. The AP 100 includes a hypervisor 10, a bridge 20, a wireless communication unit 30, and a communication controller 40 as illustrated in FIG. 2.

The communication controller 40 controls, for example, communication by the Ethernet (a registered trademark) so that communication with the server 300 is possible. The hypervisor 10 controls execution of the virtual machine. For example, the hypervisor 10 controls execution of virtual machines 11, 12, and 13 each of which executes a program performing delivery of the firmware. For example, the virtual machines 11, 12, and 13 are executed based on the execution information or the like transmitted from the servers 300a, 300b, and 300c. Since the programs are separately executed by the virtual machines, the security can be increased. Further, the firmware of the vehicle 200 that differs in the authentication scheme or the delivery file format can be delivered, for example, using the different execution information for each server 300.

The bridge 20 controls data transfer between the virtual machines 11, 12, and 13 and the wireless communication unit 30. The wireless communication unit 30 enables the virtual machines 11, 12, and 13 to perform wireless communication with the outside (the vehicle 200 or the like). For example, the wireless communication unit 30 has a function of separating a network virtually using a technique such as a virtual local area network (VLAN). FIG. 2 illustrates an example in which VLANs having service set identifiers (SSIDs) of company A, company B, and company C are set to correspond to the virtual machines 11, 12, and 13.

The security can be increased by separating the network I/F as described above. A method of separating a network is not limited to the VLAN, and any other method such as a virtual extensible local area network (VXLAN) can be applied.

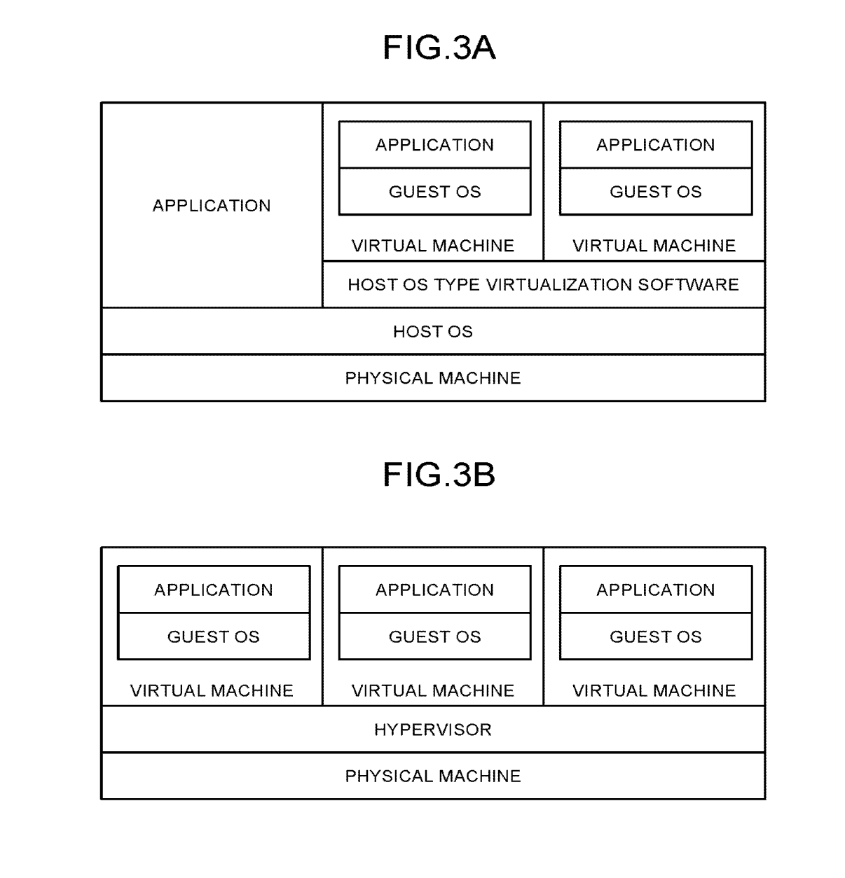

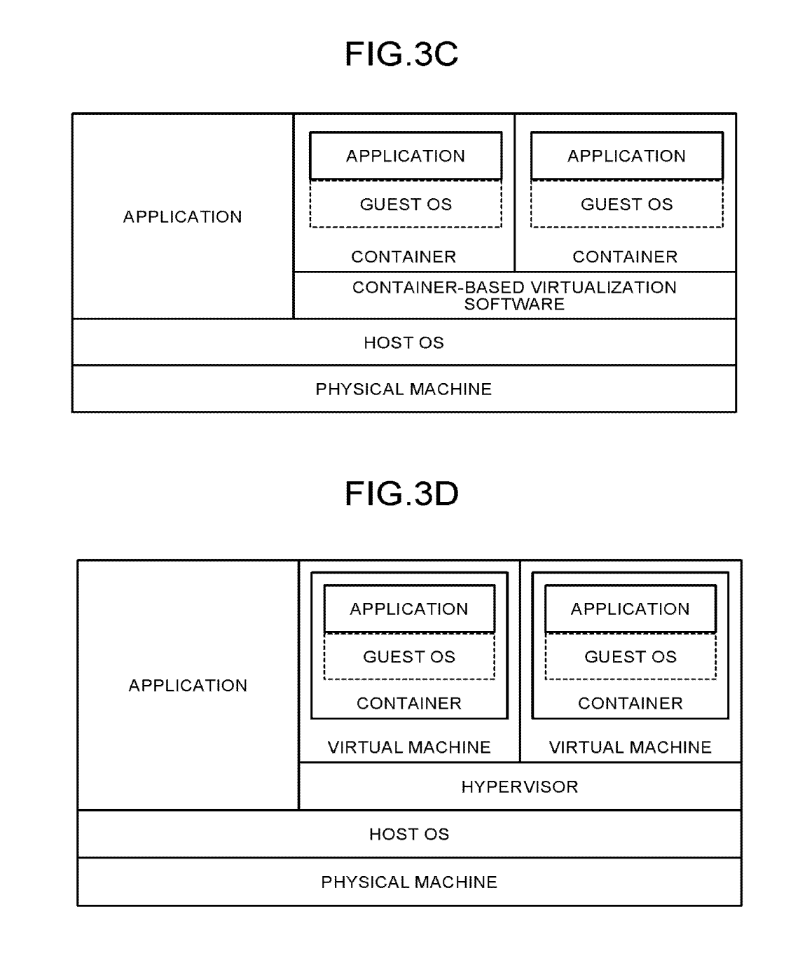

FIGS. 3A to 3D are diagrams illustrating an exemplary virtualization method. A method of implementing the virtual environment as in FIG. 2 is arbitrary, but, for example, methods illustrated in FIGS. 3A to 3D can be applied. FIGS. 3A to 3D illustrate virtualization methods of a host operating system (OS) type, a hypervisor type, a container type, and a hypervisor/container type.

In the host OS type virtualization and the hypervisor type virtualization, it is possible to create a virtual machine on virtualization software of a host OS or the hypervisor and operate the same OS as the host OS or a guest OS different from the host OS on the virtual machine. In the container-based virtualization and the hypervisor/container-based virtualization, the host OS is used as the guest OS on the container. Thus, when the guest OS is identical to the host OS, a CPU load, a memory usage, and the like can be reduced.

Each of the virtual machine and the container mostly holds a disk image in a file form as one corresponding to a storage of a physical machine. In the host OS type virtualization and the hypervisor type virtualization, the disk image is held in a form including the guest OS and an application. On the other hand, in the container-based virtualization and the hypervisor/container-based virtualization, since the guest OS uses the host OS, the guest OS is not included in the image. In both of the virtual machine and the container, the disk image is an image for executing the guest OS. Thus, hereinafter, the disk image is referred to as a guest OS executing image regardless whether or not an OS is included. The guest OS executing image corresponds to program information for executing a program performing wireless communication with the vehicle 200 (the terminal device). The guest OS executing image includes information that is commonly held in the disk image in virtualization such as a library, authentication information, and various setting information in addition to the guest OS and the application. A plurality of applications or libraries can be stored. For example, in addition to the server application that performs data delivery, a dynamic host configuration protocol (DHCP) server application or a router advertisement (RA) server application may be included as the application.

Next, a hardware configuration and a functional configuration of the devices illustrated in FIG. 1 will be described.

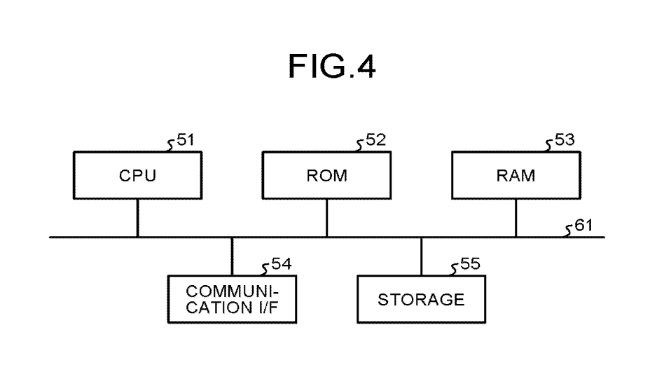

FIG. 4 is a diagram illustrating an exemplary hardware configuration of the servers 300 and 400. Each of the servers 300 and 400 includes a control device such as a central processing unit (CPU) 51, a storage device such as read only memory (ROM) 52 or random access memory (RAM) 53, a communication I/F 54 that is connected to a network and performs communication, a storage 55 that stores data, and a bus 61 that connects the respective units.

Each server 300 may be configured with a single device physically or may be configured with a plurality of devices physically. All or some servers among a plurality of servers 300 and a plurality of servers 400 may be configured with a single device physically.

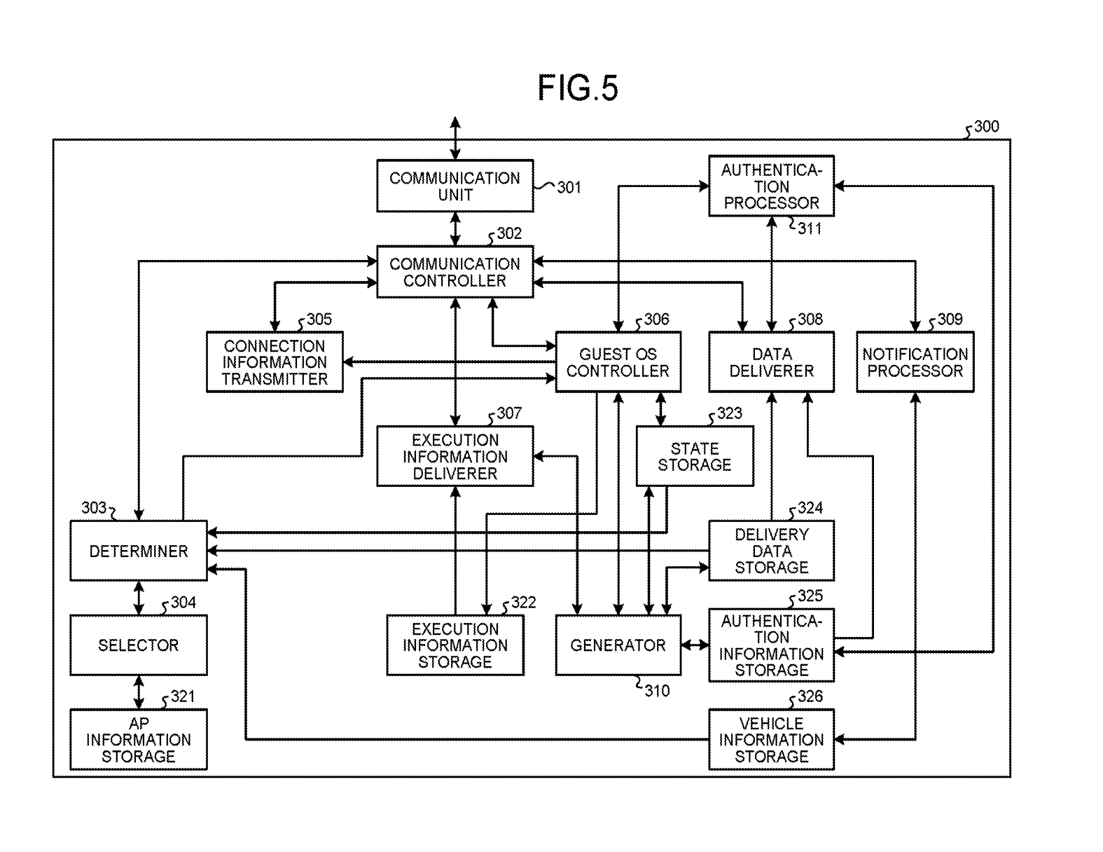

FIG. 5 is a block diagram illustrating an exemplary functional configuration of the server 300. The server 300 includes a communication unit 301, a communication controller 302, a determiner 303, a selector 304, a connection information transmitter 305, a guest OS controller 306, an execution information deliverer 307, a data deliverer 308, a notification processor 309, a generator 310, an authentication processor 311, an AP information storage 321, an execution information storage 322, a state storage 323, a delivery data storage 324, an authentication information storage 325, and a vehicle information storage 326.

The communication unit 301, the communication controller 302, the determiner 303, the selector 304, the connection information transmitter 305, the guest OS controller 306, the execution information deliverer 307, the data deliverer 308, the notification processor 309, the generator 310, and the authentication processor 311 may be implemented by executing a program through a processing device such as a CPU, that is, software, may be implemented by hardware such as an integrated circuit (IC), or may be implemented by a combination of software and hardware.

Each of the storages (the AP information storage 321, the execution information storage 322, the state storage 323, the delivery data storage 324, the authentication information storage 325, and the vehicle information storage 326) can be configured with all commonly used storage media such as a solid state drive (SSD), a hard disk drive (HDD), an optical disk, a memory card, and RAM. All or some storages may be configured with a common storage medium.

The communication unit 301 is an interface that is connected with the Internet to communicate with an external device such as the other servers 300, the server 400, the AP 100, the vehicle 200, or the cellular base station 600. The communication controller 302 controls the communication unit 301 such that information (a frame or the like) is transmitted and received.

The determiner 303 determines whether the vehicle 200 is a target to which the firmware is downloaded or uploaded or a target to which state information notification is transmitted, that is, whether the vehicle 200 is a target for which a program for delivering the firmware, receiving the uploaded firmware, and transceiving the update state notification is executed through the AP 100 with reference to the approach information received from the vehicle 200. The program for delivering the firmware is, for example, the guest OS and the delivery application. The program is executed by the virtual machine or the container that perform separate execution so that resources such as a CPU, a memory, a network, and a storage can be independently used by the above-described virtualization technique. Hereinafter, the program for delivering the firmware is also referred to simply as a “guest OS”.

The selector 304 selects the AP 100 that executes the guest OS. The connection information transmitter 305 transmits connection information to the vehicle 200. The guest OS controller 306 controls execution of the guest OS by instructing the AP 100 to activate or stop the guest OS.

The execution information deliverer 307 delivers the execution information to the AP 100. The execution information is information used to execute the guest OS that is executed by the AP 100.

The data deliverer 308 performs a transmission process of delivery information including delivery data stored in the delivery data storage according to a request made from the guest OS of the AP 100. The notification processor 309 receives and processes the update state notification transmitted from the vehicle 200 at the time of download completion or at the time of update completion.

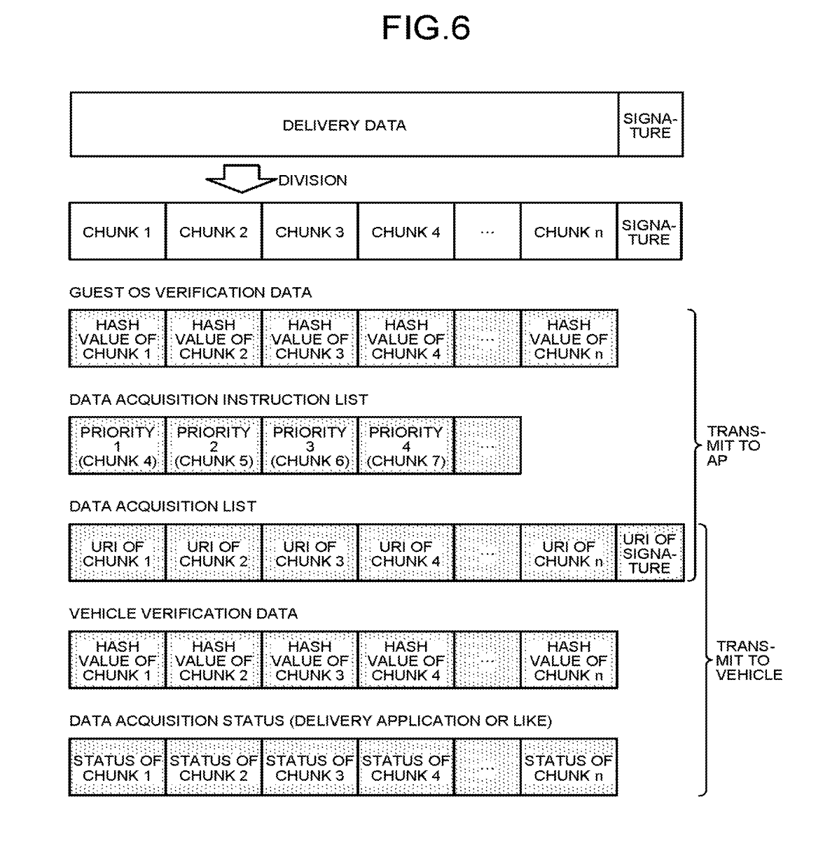

FIG. 6 is a diagram for describing a data delivery method. The delivery data such as the firmware is divided into a plurality of pieces of partial data (chunks) having a fixed length and then delivered as illustrated in FIG. 6. The divided delivery data is delivered together with various kinds of information (a data acquisition list, verification data, and the like). The delivery data division process, the guest OS verification data, the data acquisition list, the vehicle verification data, and the signature may be created through the server when an administrator of each company uploads the delivery data to the server 300 or may be created in advance before the delivery data is uploaded to the server.

The guest OS verification data, the data acquisition instruction list, and the data acquisition list are delivered from the server 300 to the AP 100. The data acquisition list, the vehicle verification data, and a data acquisition status are delivered from the AP 100 to the vehicle 200.

The guest OS verification data and the vehicle verification data are data used when a device (the AP 100 or the vehicle 200) that has received data verifies the validity of the received data. For example, a hash value calculated from each chunk may be used as the verification data. The guest OS verification data and the vehicle verification data are calculated by different calculation methods. The calculation method is shared between the server 300 and the AP 100 and between the servers in advance, or the calculation method is delivered and shared. The verification data is not limited to the hash value, and any information can be used as long as the information can be used in verifying data.

The data acquisition instruction list is information instructing an order (priority) for acquiring data (a chunk). For example, the AP 100 acquires data in order starting from data (a chunk) that is high in a priority designated by the data acquisition instruction list.

The data acquisition list is information indicating an acquisition destination of each data (a chunk and a signature). The information indicating the acquisition destination is arbitrary, but, for example, a uniform resource identifier (URI) may be used. A plurality of acquisition destinations may be described for one piece of data.

The data acquisition status is information indicating an acquisition status such as whether or not the delivery application operating on the guest OS of the AP 100 serving as a delivery source has acquired corresponding data (chunk). When the AP 100 serving as the delivery source is changed by movement or the like, the data acquisition status is acquired from the delivery application operating on the guest OS of the changed AP 100.

Referring back to FIG. 5, the generator 310 generates delivery preparation information for preparing delivery of the delivery data. The delivery preparation information includes guest OS preparation information used for delivery of the guest OS and vehicle preparation information used for delivery of the vehicle 200.

The authentication processor 311 performs the authentication process between the vehicle 200 and the AP 100.

For example, the AP information storage 321 stores position information (longitude information, latitude information, or the like), an IP address, and the like for an ID generated from a manufacturer and a serial number of the AP 100. The AP information storage 321 stores and manages the information through the server 300 as illustrated in FIG. 5 or may be implemented by acquiring data from a data providing an AP information database used in common by respective companies and caching the acquired data.

The execution information storage 322 stores an image (the guest OS executing image) used to execute the guest OS, information used to perform a setting of a network connected with the guest OS through the AP 100, and the guest OS preparation information.

The state storage 323 stores a state (an activation state or a cache state of the delivery application) of each guest OS and the like. The delivery data storage 324 stores the delivery data (firmware data or the like), the verification data, and the like. The authentication information storage 325 stores, for example, the authentication information (the certificate data, the private key, the public key) for performing an authentication among the vehicle 200, the AP 100, and the delivery application operating on the guest OS. The authentication information storage 325 may be configured to store information more safely through another storage.

The vehicle information storage 326 stores a download state and an update state of each vehicle 200.

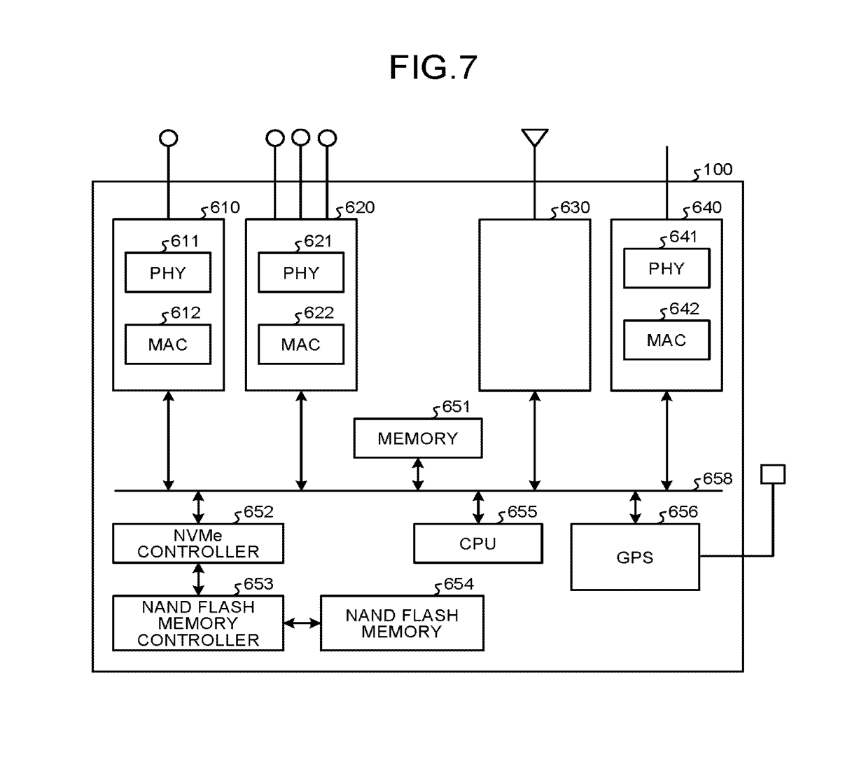

FIG. 7 is a diagram illustrating an exemplary hardware configuration of the AP 100. The AP 100 includes communication adapters 610, 620, 630, and 640, a memory 651, a non-volatile memory express (NVMe) controller 652, an NAND flash memory controller 653, NAND flash memory 654, a CPU 655, a global positioning system (GPS) 656, and a bus 658 that connects the respective units.

The communication adapter 610 is an adapter conforming to, for example, IEEE802.11p. The communication adapter 610 includes a PHY 611 that controls the physical layer and a MAC 612 that performs media access control.

The communication adapter 620 is an adapter conforming to, for example, for example, IEEE802.11n/ac/ax. The communication adapter 620 includes a PHY 621 that controls the physical layer and an MAC 622 that performs media access control.

The communication adapter 630 is an adapter that performs communication, for example, according to a cellular scheme.

The communication adapter 640 is an adapter conforming to, for example, the Gigabit Ethernet. The communication adapter 640 includes a PHY 641 that controls the physical layer and an MAC 642 that performs media access control.

The NAND flash memory controller 653 controls access to the NAND flash memory 654. The NVMe controller 652 controls access to a memory (the NAND flash memory 654) according to an NVMe.

The GPS 656 receives signals from a plurality of GPS satellites, and acquires position information of its own device.

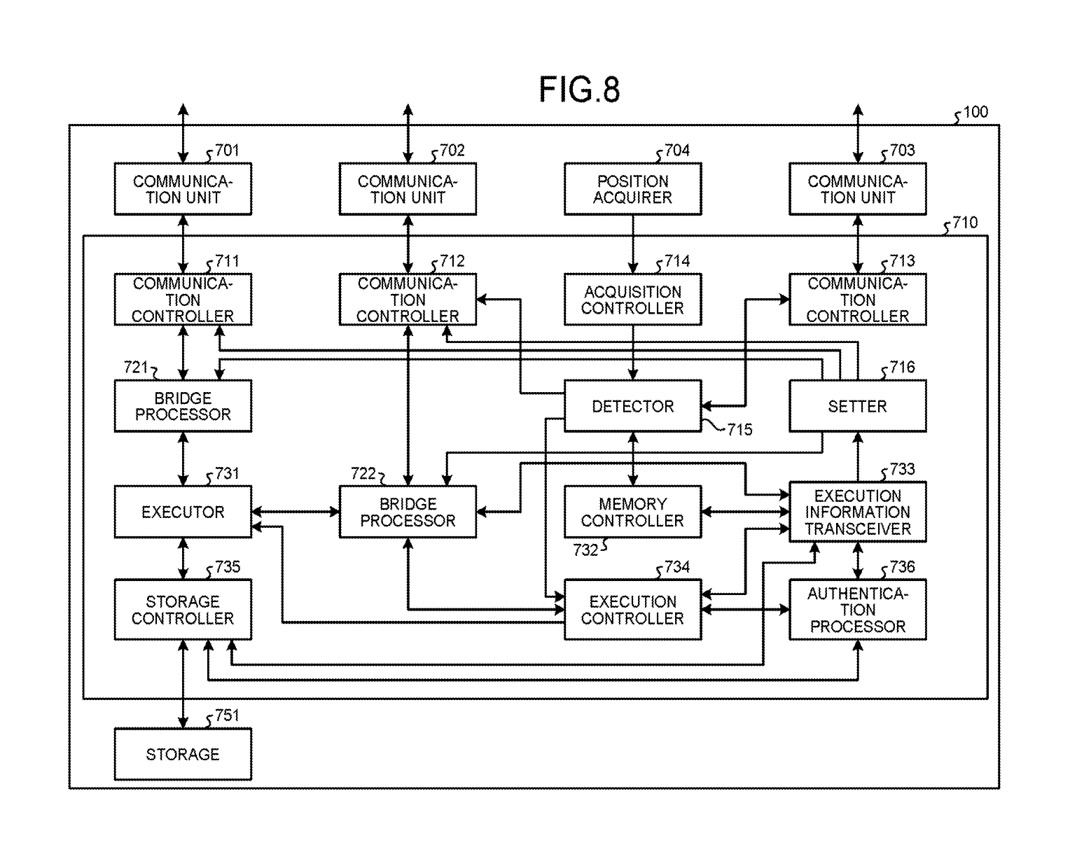

FIG. 8 is a block diagram illustrating an exemplary functional configuration of the AP 100. The AP 100 includes communication units 701, 702, and 703, a position acquirer 704, a host OS/hypervisor executor 710, and a storage 751.

For example, the host OS/hypervisor executor 710 is implemented by executing a program through a processing device such as the CPU 655, that is, software.

The storage 751 can be configured with all commonly used storage media such as an SSD, a HDD, an optical disk, a memory card, and RAM. In the example of FIG. 7, for example, the memory 651 and the NAND flash memory 654 can be applied as the storage 751.

The communication unit 701 performs communication with the vehicle 200 to transmit or receive the delivery data. For example, the communication unit 701 is implemented by communication by a service channel (SCH) of the communication adapter 620 (a high speed communication wireless LAN adapter) or the communication adapter 610 (a vehicle communication wireless LAN adapter).

The communication unit 702 is connected with the Internet backbone (the Internet 500), and performs communication with the server 300 and the server 400. For example, the communication unit 702 is implemented by the communication adapter 630 and the communication adapter 640.

The communication unit 703 performs transmission and reception of information such as the approach information and the connection information with the vehicle 200. The communication unit 703 is implemented by communication by control channel (CCH) of the communication adapter 620 or the communication adapter 610.

The position acquirer 704 acquires the position information of the AP 100. The position acquirer 704 is implemented by, for example, the GPS 656.

The host OS/hypervisor executor 710 includes communication controllers 711, 712, and 713, an acquisition controller 714, a detector 715, a setter 716, bridge processors 721 and 722, an executor 731, a memory controller 732, an execution information transceiver 733, an execution controller 734, a storage controller 735, and an authentication processor 736.

The communication controller 711, the communication controller 712, and the communication controller 713 control the communication units 701, 702, and 703 such that data (a frame or the like) is transmitted or received.

The acquisition controller 714 controls the position acquirer 704. The detector 715 detects that the vehicle 200 has been connected to the communication unit 703 and transmitted the approach information.

The bridge processor 721 transfers communication with the communication controller 711 through the data link layer of the OSI reference model. The bridge processor 722 transfers communication with the communication controller 712 through the data link layer of the OSI reference model.

The executor 731 executes the guest OS executing image (the guest OS, the delivery application, or the like). The executor 731 can be also interpreted to indicate the guest OS (and the delivery application) being executed through the execution controller 734. When a plurality of guest OSs are executed, there are a plurality of executors 731. The execution controller 734 executes the guest OS based on the execution information received from the server 300.

The execution information transceiver 733 performs transmission and reception of the execution information. The execution information transceiver 733 corresponds to a receiver that receives the guest OS executing image (included in the execution information). In the present embodiment, the execution information transceiver 733 uses only the receiving function but may function as a transmitter that transmits the guest OS executing image as will be described later. The setter 716 sets a network to the communication controller 711, the communication controller 712, the bridge processor 721, and the bridge processor 722. For example, the setter 716 sets a wireless network through the communication controller 711 or the like so that the guest OS performs communication with the vehicle 200 using a wireless network corresponding to the guest OS.

The authentication processor 736 performs server authentication and client authentication in communication with the server 300. The storage controller 735 controls the storage 751 such as reading or writing are performed.

The memory controller 732 stores the connection information in which there was a response previously in a cache storage. The cache storage can be implemented by, for example, the memory 651 and the storage 751.

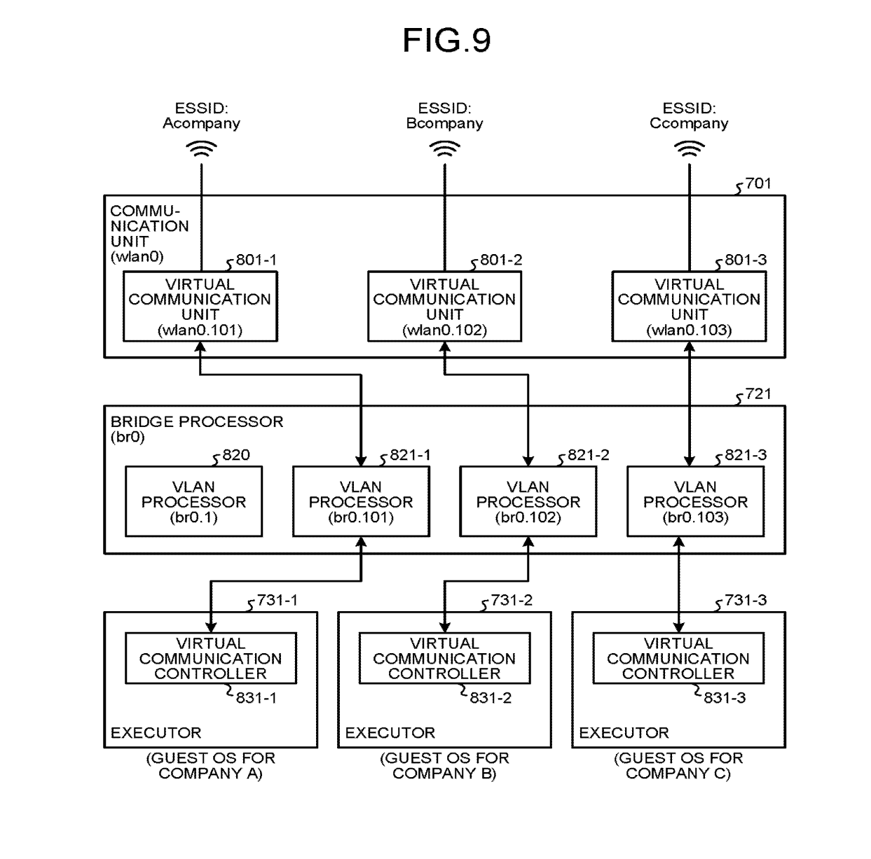

FIG. 9 is a diagram illustrating an exemplary configuration of a virtual network in the AP 100. FIG. 9 illustrates an example of configuring three virtual networks having the SSIDs of company A, company B, and company C as in FIG. 2. In FIG. 9, the communication unit 701 and the bridge processor 721 are described as an example, but, for example, the communication unit 702 and the bridge processor 722 can configure a virtual network using a similar method as well.

The communication unit 701 and the bridge processor 721 support the VLAN, and can create a trunk port that transmits or receives a frame including a VLAN ID (a VLAN tag) and an access port belonging to a specific VLAN ID. In this example, the trunk port (wlan0) of the communication unit 701 is connected with the trunk port (br0) of the bridge processor. The communication unit 701 is configured to include three virtual communication units, that is, a virtual communication unit 801-1 that is implemented by an access port (wlan0.101) belonging to a VLAN ID 101, a virtual communication unit 801-2 that is implemented by an access port (wlan0.101) belonging to a VLAN ID 102, and a virtual communication unit 801-3 that is implemented by an access port (wlan0.101) belonging to a VLAN ID 103. The bridge processor 721 is configured to include a VLAN processor 820 that is implemented by an access port (br0.1) belonging to a VLAN ID 1 (a default VLAN), a VLAN processor 821-1 that is implemented by an access port (br0.101) belonging to the VLAN ID 101, a VLAN processor 821-2 that is implemented by an access port (br0.102) belonging to the VLAN ID 102, and a VLAN processor 821-3 that is implemented by an access port (br0.103) belonging to the VLAN ID 103. The VLAN processors 821-1, 821-2, and 821-3 are connected to the virtual communication units 801-1, 801-2, and 801-3.

For example, the executors 731-1, 731-2, and 731-3 are three guest OSs corresponding to the virtual machines 11, 12, and 13 of FIG. 2. The executors 731-1, 731-2, and 731-3 include virtual communication controllers 831-1, 831-2, and 831-3, respectively. The virtual communication controllers 831-1, 831-2, and 831-3 are connected to the VLAN processor 821-1, 821-2, 821-3, respectively. For example, the VLAN tag (the VLAN ID 101) is added to a communication frame of an extended service set (ESS) having an SSID (ESSID) of “Acompany” through the virtual communication unit 801-1 when output from the trunk port of the communication unit 701. The bridge processor 721 receives the frame including the VLAN tag (the VLAN ID 101) added thereto, removes the VLAN tag, and outputs the frame from which the VLAN tag has been removed to the VLAN processor 821-1 serving as the access port of the VLAN ID 101. The frame from which the VLAN tag has been removed is output to the virtual communication controller 831-1. An inverse process is performed when output from the virtual communication controller 831-1. As described above, a network to which a different VLAN ID is separated, a connection is performed via a network in which an ESS and a corresponding virtual machine are independent, and thus separation of a network of an irrelevant ESs or an irrelevant virtual machine can be implemented.

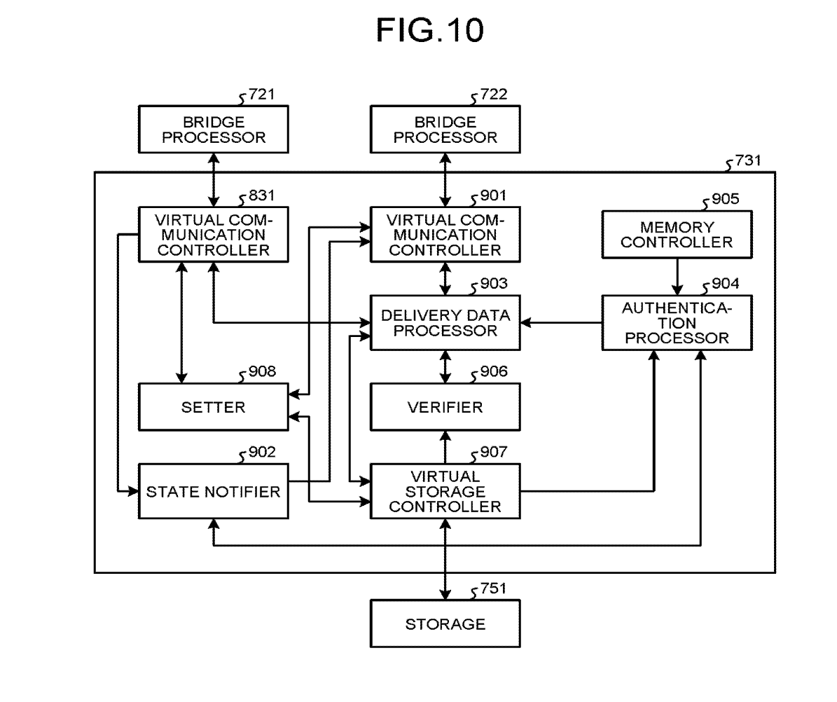

FIG. 10 is a block diagram illustrating an exemplary detailed functional configuration of the executor 731. The executor 731 includes virtual communication controllers 831 and 901, a state notifier 902, a delivery data processor 903, an authentication processor 904, a memory controller 905, a verifier 906, a virtual storage controller 907, a setter 908 as illustrated in FIG. 10.

The virtual communication controller 831 is connected with the bridge processor 721, and configures a virtually independent network through the VLAN, the VXLAN, or the like. Through this function, the virtual communication controller 831 is connected to a network isolated from an ESS configured for the guest OS through the communication unit 701, and performs communication with the vehicle 200.

The virtual communication controller 901 is connected with the bridge processor 722 of the AP 100, and performs communication with the server 300 through the communication unit 702 of the AP 100.

The setter 908 performs a network setting of the virtual communication controller 831 and the virtual communication controller 901 based on the network setting information of the guest OS transferred from the guest OS execution controller 734 of the AP 100. For example, when information for address distribution by a DHCP or an RA is included in the network setting information, after activated, the setter 908 provides a function of a DHCP server or an RA server, and distributes an IP address, a netmask, domain name system (DNS) server information, and the like in response to a request made from the virtual communication controller 831 or the virtual communication controller 901.

The memory controller 905 stores the authentication information used in authentication of communication with the vehicle 200 for each cache storage. The cache storage can be implemented by, for example, the memory 651 and the storage 751. When the storage 751 is used as the cache storage, the memory controller 905 may be connected with the storage 751 via the virtual storage controller 907.

The authentication processor 904 performs the authentication process of communication with the vehicle 200 or the server 300 using the authentication information stored in the cache storage or the storage.

The delivery data processor 903 acquires the delivery information from the server 300, another AP 100, or the like through the virtual communication controller 901. The delivery data processor 903 performs a reception process of data delivery to the vehicle 200 or data download from the vehicle 200 through the virtual communication controller 831.

The verifier 906 performs the verification process of delivered data or uploaded data using the guest OS verification data.

The virtual storage controller 907 is connected with the storage controller 735 of the AP 100, and provides a storage function in the guest OS. For example, the virtual storage controller mounts and accesses a disk image held as a file in the storage 751 of the AP 100 through the storage controller 735 of the AP 100.

The state notifier 902 receives the update state notification from the vehicle 200 through the virtual communication controller 831, and transmits the update state notification to the server 300 through the virtual communication controller 901.

The virtual communication controller 831, the virtual communication controller 901, and the virtual storage controller 907 are implemented by, for example, the guest OS. The remaining function units (the state notifier 902, the delivery data processor 903, the authentication processor 904, the memory controller 905, and the verifier 906) are implemented by, for example, the delivery application.

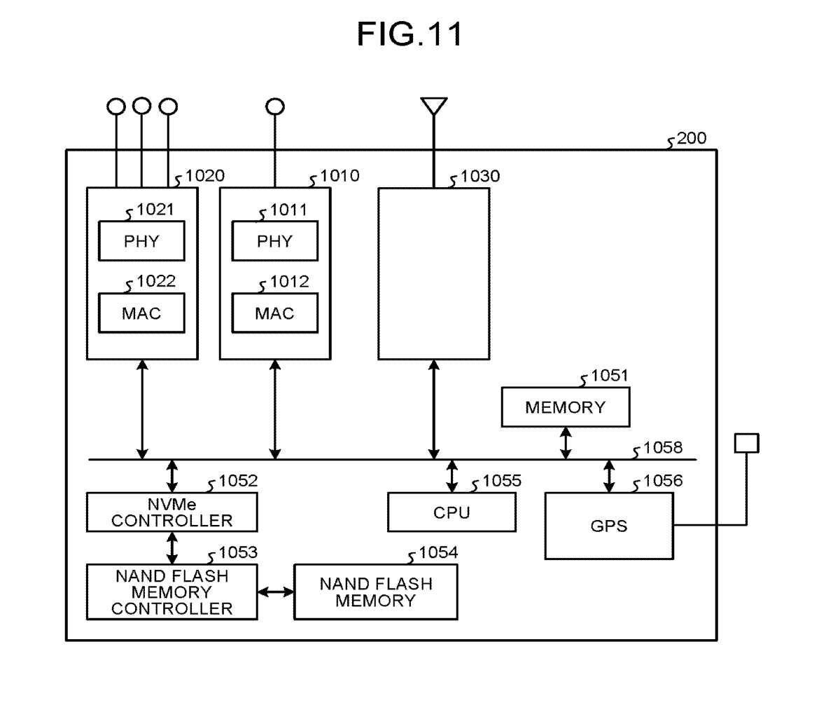

FIG. 11 is a diagram illustrating an exemplary hardware configuration of the vehicle 200. The vehicle 200 includes communication adapters 1010, 1020, and 1030, a memory 1051, an NVMe controller 1052, an NAND flash memory controller 1053, NAND flash memory 1054, a CPU 1055, a GPS 1056, and a bus 1058 that connects the respective units.

The communication adapter 1010 is an adapter conforming to, for example, IEEE802.11p. The communication adapter 1010 includes a PHY 1011 that controls the physical layer and an MAC 1012 that performs media access control.

The communication adapter 1020 is an adapter conforming to, for example, IEEE802.11n/ac/ax. The communication adapter 1020 includes a PHY 1021 that controls the physical layer and an MAC 1022 that performs media access control.

The communication adapter 1030 is an adapter that performs communication conforming to, for example, a cellular scheme. As described above, the vehicle 200 differs the hardware configuration (FIG. 7) of the AP 100 in that the communication adapters 1010, 1020, and 1030 corresponding to the communication adapters 610, 620, and 630 of the AP 100 are arranged, and the adapter corresponding to the communication adapter 640 is not arranged.

The memory 1051, the NVMe controller 1052, the NAND flash memory controller 1053, the NAND flash memory 1054, the CPU 1055, the GPS 1056, and the bus 1058 are similar to the memory 651, the NVMe controller 652, the NAND flash memory controller 653, the NAND flash memory 654, the CPU 655, the GPS 656, and the bus 658 of the AP 100.

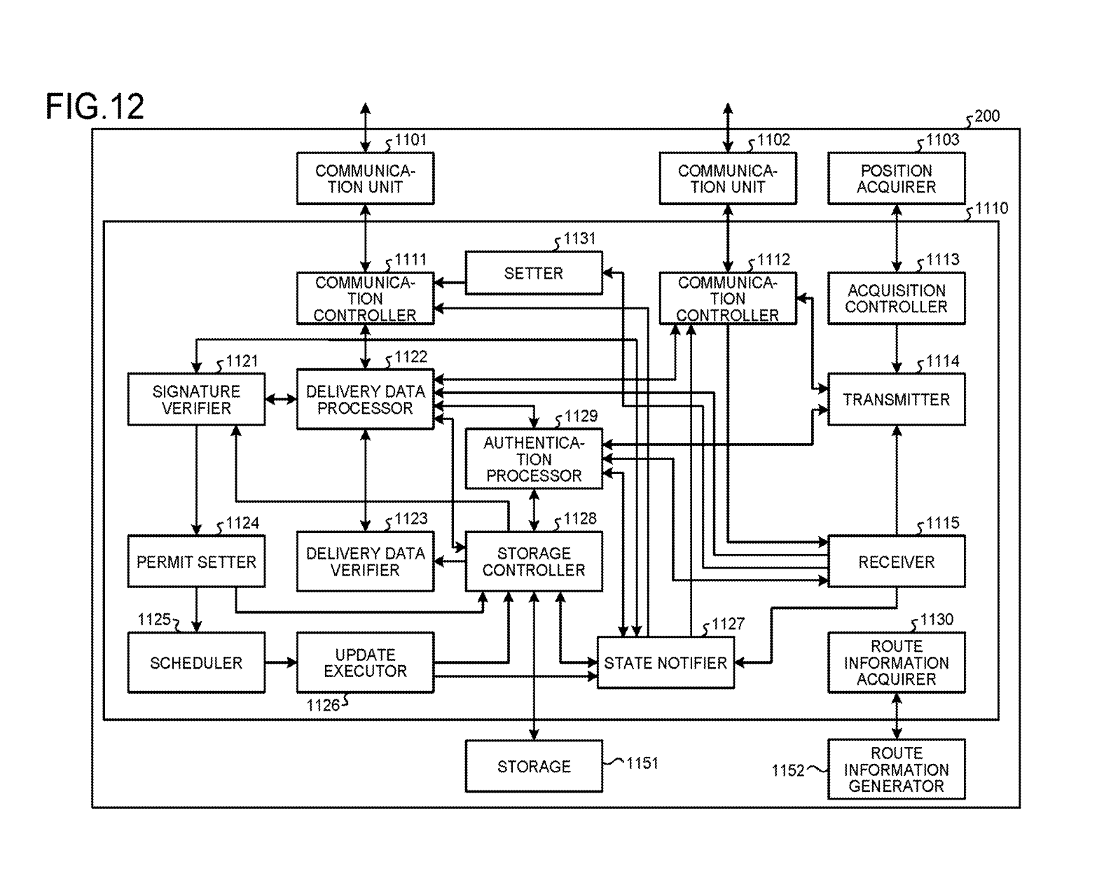

FIG. 12 is a block diagram illustrating an exemplary functional configuration of the vehicle 200. The vehicle 200 includes communication units 1101 and 1102, a position acquirer 1103, a program executor 1110, a storage 1151, and a route information generator 1152.

The program executor 1110 is implemented by executing a program through a processing device such as the CPU 1055, that is, software.

The storage 1151 can be configured with all commonly used storage media such as an SSD, a HDD, an optical disk, a memory card, and RAM. In the example of FIG. 11, for example, the memory 1051 and the NAND flash memory 1054 can be applied as the storage 1151. The storage 1151 stores various information, for example, vehicle information, the authentication information such as the certificate, the delivery information, and the like. For example, the storage may be shared with another device.

The communication unit 1101 performs communication with the AP 100. For example, the communication unit 1101 is implemented by communication by the service channel (SCH) of the communication adapter 1020 (the high speed communication wireless LAN adapter) or the communication adapter 1010 (the vehicle communication wireless LAN adapter).

The communication unit 1102 is connected with the Internet backbone (the Internet 500), and performs communication with the server 300 and the server 400. For example, the communication unit 1102 is implemented by communication by the control channel (CCH) of the communication adapter 1020 or the communication adapter 1010 or the communication adapter 1030.

The position acquirer 1103 acquires the position information of the vehicle 200. The position acquirer 1103 is implemented by, for example, the GPS 1056. The route information generator 1152 is implemented by a car navigation system or the like, and generates route information indicating a movement route (a travel route) of the vehicle 200.

The program executor 1110 includes communication controllers 1111 and 1112, an acquisition controller 1113, a transmitter 1114, a receiver 1115, a signature verifier 1121, a delivery data processor 1122, a delivery data verifier 1123, a permit setter 1124, a scheduler 1125, an update executor 1126, a state notifier 1127, a storage controller 1128, an authentication processor 1129, a route information acquirer 1130, and a setter 1131.

The communication controllers 1111 and 1112 control the communication units 1101 and 1102, respectively, such that data (a frame or the like) is transmitted or received.

The acquisition controller 1113 controls the position acquirer 1103. The transmitter 1114 transmits the approach information to the server 300 through the communication controller 1112 and the communication unit 1102. The receiver 1115 receives the connection information transmitted from the server 300 through the communication unit 1102 and the communication controller 1112, and transfers the information to the transmitter 1114, the setter 1131, the delivery data processor 1122, the state notifier 1127, and the authentication processor 1129.

The signature verifier 1121 verifies a digital signature of the server 300 when downloading of the firmware is completed.

The delivery data processor 1122 performs communication with the delivery application operating on the guest OS of the AP 100 through the communication unit 1101 and the communication controller 1111, and performs downloading or uploading of the delivery data. The delivery data verifier 1123 verifies the delivered data.

When the verification performed by the signature verifier 1121 is successfully, the permit setter 1124 sets information permitting update execution by the firmware to the storage 1151. The scheduler 1125 schedules the update execution. The update executor 1126 executes an update process according to a schedule.

The state notifier 1127 notifies the server 300 of download completion, update completion, or update failure of the firmware through the communication unit 1101 or the communication unit 1102.

The storage controller 1128 controls the storage 1151 such that reading or writing of each unit is controlled. The authentication processor 1129 performs the authentication process using the authentication information stored in the storage 1151. The route information acquirer 1130 acquires the route information from the route information generator 1152. The setter 1131 performs a network setting of the communication unit 1101 based on the network setting information included in the connection information received through the receiver 1115.

The communication unit 1101 and the communication unit 1102 may be a communication unit configured with one communication adapter, and in this case, the communication controller 1111 and the communication controller 1112 may be one communication controller as well.

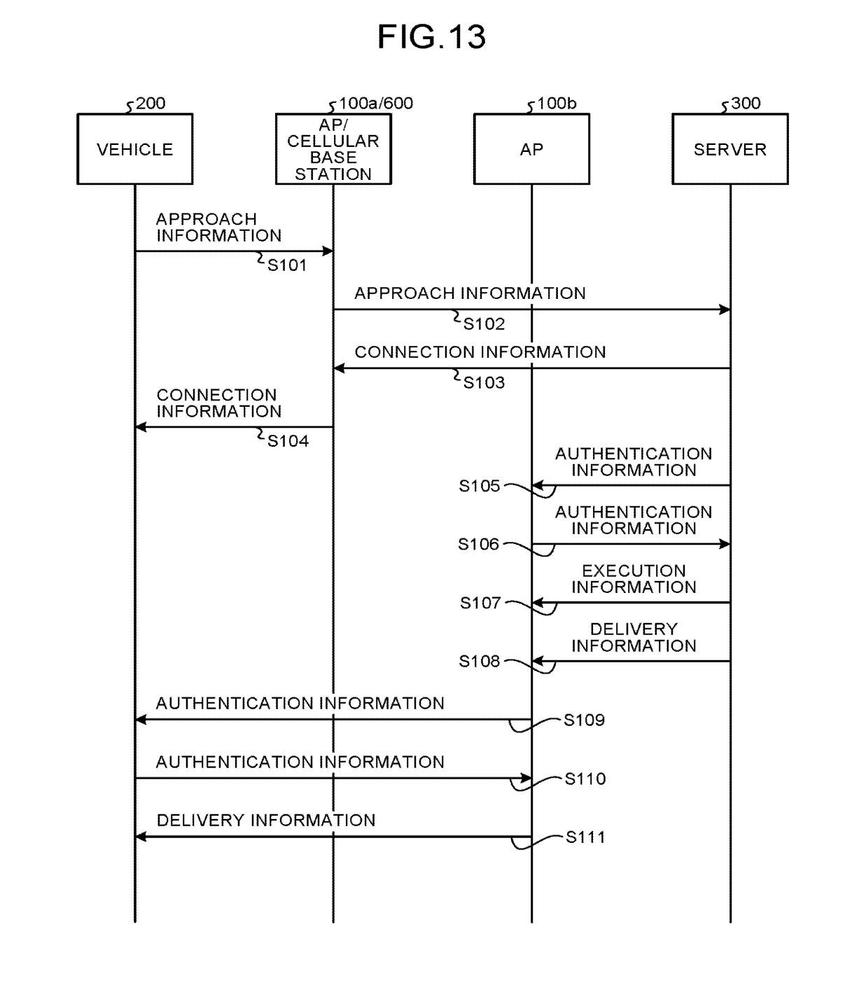

Next, the data delivery process performed by the communication system of the present embodiment having the above configuration will be described with reference to FIG. 13. FIG. 13 is a sequence diagram illustrating an exemplary overall flow of the delivery process according to the present embodiment.

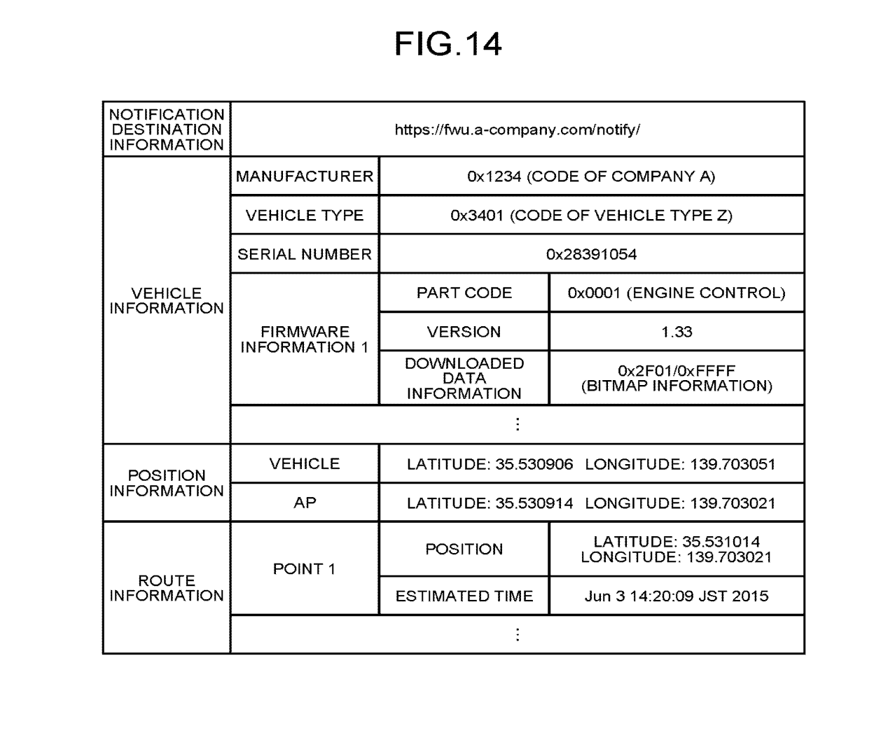

The vehicle 200 transmits the approach information to the AP 100 (the AP 100a) or the cellular base station 600 which the vehicle 200 has approached (step S101). FIG. 14 is a diagram illustrating an exemplary data structure of the approach information.

The approach information includes the notification destination information, the vehicle information, the position information, and the route information as illustrated in FIG. 14. The notification destination information is information specifying the server 300 serving as a destination that is notified of the approach information. For example, a uniform resource locator (URL) of the server 300 may be used as the notification destination information as illustrated in FIG. 14. For example, the AP 100a may receive the approach information from the vehicle 200, be connected to the server 300 designated by the notification destination information according to the HTTPS, and transmit the remaining approach information, or the vehicle 200 may notify the server 300 of the approach information directly. In the latter case, the notification destination information is stored as a destination of an IP header when communication is performed according to the HTTPS.

The vehicle information is information including, for example, an attribute of a vehicle. For example, the vehicle information includes a manufacturer, a vehicle type, a serial number, and firmware information. The firmware information includes information (part code) specifying a firmware type, a firmware version, and downloaded data information. The downloaded data information is indicated by a mask (which may be a length) indicating the number of all chunks and a bitmap of each chunk data when one chunk is downloaded. The part code is information indicating a part of the vehicle 200 corresponding to the firmware. For example, the part code is used to identify whether the firmware is firmware of an engine controller or firmware of the car navigation system. The part code may include information of a manufacturer of a part. As described above, when there are a plurality of pieces of firmware, a plurality of pieces of firmware information are created.

The position information includes at least the position information of the vehicle 200. The position information of the AP 100 may be added when the approach information is transmitted from the AP 100 to the server 300. For example, when the position of the AP 100 is fixed, and the server 300 has the position of the AP 100 in advance, the position information of the AP 100 may not be included in the approach information.

The route information decided by the car navigation system or the like is set as the route information. For example, when it is difficult to acquire the route information from the car navigation system, the route information may not be included in the approach information.

Referring back to FIG. 13, the AP 100a transmits the received approach information to the destination (the server 300) designated by the notification destination information (step S102). Upon receiving the approach information, the server 300 transmits the connection information to the AP 100a or the cellular base station 600 (step S103). The AP 100a or the cellular base station 600 transmits the received connection information to the vehicle 200 (step S104). Further, when downloading and uploading of the approach information and transmission of update information are determined to be unnecessary, the server 300 may not transmit the connection information or may transmit a message notifying of that no approach information will be transmitted for a while.

The connection information includes information of a connection destination when the vehicle 200 performs transmission or reception of the delivery data. An exemplary data structure of the connection information will be described below. For example, the connection information includes instruction information, the vehicle preparation information, the authentication information, the network setting information, and AP information. The connection information may include the information for each firmware. In this case, the connection information may include a part code or version information indicating firmware to which the information belongs.

The instruction information is information instructing whether data is downloaded or uploaded. The vehicle preparation information includes data acquisition list acquisition destination information, vehicle verification data acquisition destination information, upload destination information, update state notification destination information, and data acquisition status acquisition destination information.

The data acquisition list acquisition destination information is information indicating an acquisition destination of the data acquisition list. The vehicle verification data acquisition destination information is information indicating an acquisition destination of the vehicle verification data. The upload destination information is information indicating an upload destination of data. The update state notification destination information is information indicating a notification destination of the update state notification. The data acquisition status acquisition destination information is information indicating an acquisition destination of the data acquisition status. A form of the information indicating the acquisition destination, the upload destination, and the notification destination is arbitrary, but, for example, a URI that is accessed according to the HTTPS may be used.

The authentication information may include, for example, a delivery application server certificate and a public key. For example, when the authentication is not executed, the connection information may not include the authentication information.

The network setting information is information necessary for a network setting used for transmission and reception of data. For example, the network setting information includes identification information (an ESSID, a BSSID, or the like) identifying a wireless network, wireless LAN security information (a passphrase of the WEP/WPA/WPA2 or the like), and the like. The network setting information may include an IP address, a netmask, a prefix length, DNS server information such as a DNS server address, routing information, and the like, and the information may be set through the DHCP server, the RA server, or the like after wireless LAN connection. For example, when the network setting information is fixed in advance, the connection information may not include the network setting information. When the network setting information is fixed in advance, an SSID may be generated using all or some of a manufacturer, a vehicle type, a serial number (in which a range can be designated), a firmware type, and a firmware version.

The AP information is information related to the AP 100 with which communication is performed, and includes, for example, an estimated time until it enters a connectable range, position of a connectable range, and the like. The AP information may not be included in the connection information.

Referring back to FIG. 13, the server 300 transmits the authentication information to the AP 100b (step S105). The AP 100b transmits the authentication information to the server 300 (step S106). As a result, the authentication process is executed between the server 300 and the AP 100b. Then, the server 300 transmits the execution information and the delivery information (the delivery information for the guest OS) to the AP 100b (step S107, step S108). The AP 100b is the AP 100 selected as the acquisition destination at which the vehicle 200 acquires the delivery data. A method of selecting the AP 100 will be described later.

Here, exemplary data structures of the execution information and the delivery information will be described. The execution information includes the image (the guest OS executing image) for executing the guest OS, the network setting information, and the guest OS preparation information.

The image for executing the guest OS is, for example, a virtual machine image or a container image. For example, in the container type, since the host OS is used, an image of the guest OS may not be included as unnecessary.

For example, the network setting information includes the network setting information of the communication unit 701, the network setting information of the communication unit 702, and the network setting information of the guest OS.

The network setting information of the communication unit 701 includes an ESSID serving as an ID of an ESS, security information, and the like as parameters of a wireless LAN network used by a wireless LAN network to be created. For example, the security information is a WEP password and a passphrase of WPA/WPA2. The network setting information may be configured to further include a BSSID designated by the server 300 and be set to the AP.

For example, the network setting information of the communication unit 702 includes setting information (a VLAN/VXLAN ID) of the VLAN or the VXLAN or setting information of the VPN when the communication unit 702 is implemented by the Gigabit Ethernet communication adapter (the communication adapter 640).

For example, the network setting information of the guest OS includes the IP address, the netmask, the prefix length, the DNS server information, and the routing information of the virtual communication controller 831, an address range (an IP address range provided by the DHCP) used for communication of the virtual communication controller 831, prefix information of IPv6 advertised by an RA, and the IP address, the netmask, the prefix length, the DNS server information, and the routing information of the virtual communication controller 901.

For example, the guest OS preparation information includes authentication information acquisition destination information, the data acquisition list acquisition destination information, guest OS verification data acquisition destination information, the vehicle verification data acquisition destination information, the upload destination information, the update state notification destination information, the data acquisition status acquisition destination information, and the data acquisition instruction list (which may be replaced with data acquisition instruction list acquisition destination information).

The authentication information acquisition destination information is information indicating an acquisition destination of the authentication information. For example, the authentication information includes a certificate and a public key used when the client authentication of the vehicle 200 is used. The guest OS verification data acquisition destination information is information indicating an acquisition destination of the guest OS verification data. The data acquisition instruction list acquisition destination information is information indicating an acquisition destination of the data acquisition instruction list.

The AP 100 can execute the guest OS so that the delivery data can be transmitted or received through the communication units 701 and 702 using the information included in the execution information.

For example, the delivery information (the delivery information for the guest OS) transmitted from the server 300 to the AP 100 includes the authentication information (the public key of the client authentication of the vehicle 200), the data acquisition list, the guest OS verification data, the vehicle verification data, the data acquisition instruction list, and the delivery data (the chunk and the digital signature of the firmware or the like). The information can be acquired by accessing the acquisition destination included in the preparation information.

For example, the delivery information (the delivery information for the vehicle) transmitted from the AP 100 to the vehicle 200 includes the data acquisition list, the vehicle verification data, the data acquisition status, and the delivery data.

Referring back to FIG. 13, the AP 100b transmits the authentication information to the vehicle 200 (step S109). The vehicle 200 transmits the authentication information to the AP 100b (step S110). As a result, the authentication process is executed between the AP 100b and the vehicle 200. When the authentication process is successfully performed, the AP 100b transmits the delivery information to the vehicle 200 (step S111).

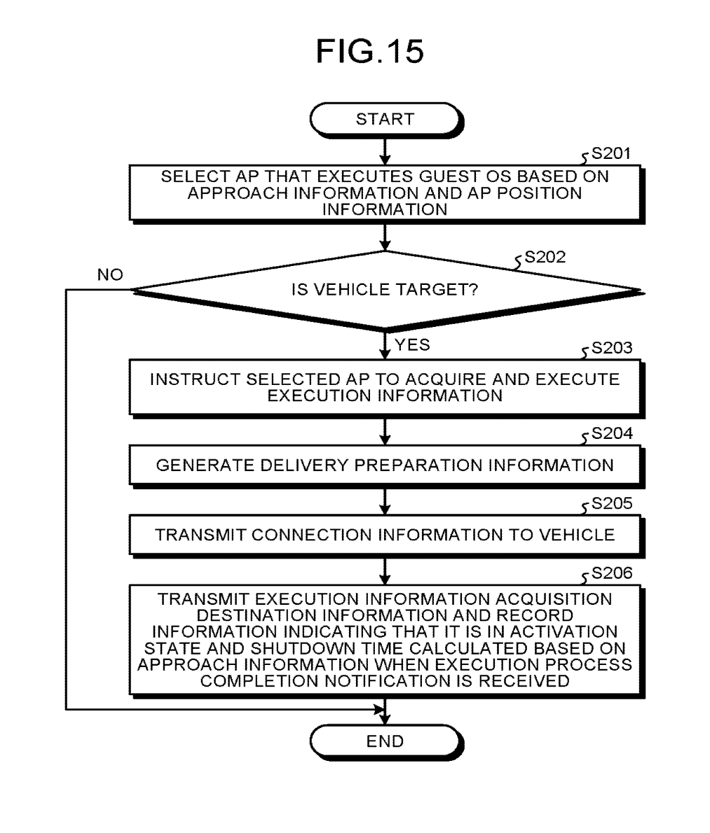

Next, a process in the server 300 when the approach information is transmitted from the vehicle 200 via the cellular network or the AP 100 will be described. FIG. 15 is a flowchart illustrating an example of this process.

The approach information transmitted from the vehicle 200 is transmitted to the server 300 designated in the notification destination information included in the approach information through the base station 600 of the cellular network or the AP 100.

In the server 300, the determiner 303 receives the approach information through the communication unit 301 and the communication controller 302. In order to select the AP 100 that activates the guest OS and performs the delivery, the determiner 303 notifies the selector 304 of the approach information and causes the selector 304 to select the AP 100.

The AP information storage 321 stores, for example, the position information and the IP address of the AP 100. The selector 304 selects the AP 100 that activates the guest OS with reference to the position information of the vehicle 200 or the AP 100 included in the provided approach information, the route information when the route information of the approach information is included, the position information of each AP 100 stored in the AP information storage 321, and the like (step S201). The details of a selection method performed by the selector 304 will be described later.

When the AP 100 that activates the guest OS is selected by the selector 304, a notification indicating the result is given to the determiner 303. The selection result includes information such as an ID, the position information, and an IP address of the selected AP. The determiner 303 determines whether or not the vehicle 200 that has transmitted the approach information is a processing target (step S202). For example, the determiner 303 determines whether the vehicle 200 is a firmware download instruction target, a firmware upload instruction target, or an update state notification transmission operation target. For example, the determiner 303 performs the determining with reference to the following information:
the vehicle information included in the approach information;
data of the firmware stored in the delivery data storage 324;
the vehicle information stored in the vehicle information storage 326; and
the selection result of the AP 100; and
the holding state of the delivery data stored in the state storage 323 in the selected AP 100.

For example, when a latest version number of the firmware that is stored in the delivery data storage 324 and applicable to the vehicle 200 is larger than a firmware version number of the vehicle information included in the approach information, and the downloaded data information included in the vehicle information of the approach information indicates that all the firmware data of the latest version has been completely downloaded, the determiner 303 determines that the vehicle 200 is the firmware download instruction target.

The determiner 303 determines whether or not it is possible to upload a portion in which there is no chunk in the latest firmware delivered by the guest OS of the selected AP 100 from the vehicle 200 with reference to a the firmware cache state in the guest OS of the selected AP 100 from the state storage 323, the firmware version included in the vehicle information of the approach information, and the downloaded data information. When it is possible to upload the portion, the determiner 303 determines that the vehicle 200 is the firmware upload instruction target. At this time, the determiner 303 corrects the selection result of the AP 100 so that a non-corresponding AP 100 does not become a guest OS activation target.

The determiner 303 refers to the firmware version of the vehicle information of the approach information and the current version information stored in the vehicle information storage 326, and determines that the vehicle 200 is the update state notification transmission operation target when the firmware version of the vehicle information of the approach information is different from the current version information stored in the vehicle information storage 326.

When the vehicle 200 is determined to be none of the download instruction target, the upload instruction target, and the update state notification transmission operation target (No in step S202), the process ends.

When the vehicle 200 is determined to be the processing target (Yes in step S202), the determiner 303 transfers the approach information, the selection result of the AP 100, and the determination result (the instruction information) of the determiner 303 to the guest OS controller 306, and instructs the guest OS controller 306 to activate the guest OS (step S203). When the vehicle 200 is the download instruction target or the upload instruction target, the determiner 303 transfers firmware to be downloaded or uploaded and a version of the firmware to the guest OS controller 306 as well.

Upon receiving the instruction from the determiner 303, the guest OS controller 306 transfers the information transferred from the determiner 303, and instructs the generator 310 to generate the delivery preparation information.

The generator 310 generates the delivery preparation information according to the instruction (step S204). First, the generator 310 selects data to be included in the delivery preparation information from the delivery data storage 324 and the authentication information storage 325. The generator 310 searches for a private key of a server certificate of an application that delivers the firmware and a public key of a client certificate of the vehicle 200 that receives the firmware based on information (a manufacturer, a vehicle type, a serial number, a firmware type, and a firmware version) included in the vehicle information of the approach information. The generator 310 adds the authentication information acquisition destination information for accessing the keys to the guest OS preparation information.

Then, the generator 310 searches for the data acquisition list (chunk data of the firmware and acquisition destination information of the signature) of each firmware stored in the delivery data storage 324, the guest OS verification data, and the vehicle verification data, acquires a URI for accessing the information, and adds the data acquisition list acquisition destination information, the guest OS verification data acquisition destination information, and the vehicle verification data acquisition destination information to the guest OS preparation information. For example, as the data acquisition list, a list that changes for each guest OS of the AP 100 may be distributed so that the acquisition destination of the server 300 is acquired from the guest OS operating on another AP 100.

The generator 310 writes the data acquisition list acquisition destination information and the vehicle verification data acquisition destination information in the vehicle preparation information.

The generator 310 decides a chunk of the firmware to be cached by the AP 100 with reference to the downloaded data information included in the approach information, the position information of the AP 100 stored in the AP information storage 321, and the cache state of the firmware in each guest OS stored in the state storage 323. The generator 310 generates the data acquisition instruction list in which a download order is defined by a priority for each guest OS, and adds the data acquisition instruction list to the guest OS preparation information. The guest OS preparation information may be generated for each group of guest OSs to which the same chunk data is expected to be delivered. A priority calculation will be described later. In the case of the upload instruction target and in the case of the update state notification transmission operation target, the generator 310 may causes the data acquisition instruction list to be null or may not transmit the data acquisition instruction list.

The generator 310 generates the data acquisition status acquisition destination information, and adds the data acquisition status acquisition destination information to the guest OS preparation information and the vehicle preparation information. The data acquisition status acquisition destination information is a URI for checking a chunk of the firmware that is cached by the delivery application executed on the guest OS of the AP 100. The AP 100 need not have a file corresponding to this URI, and may include a program that performs a process when there is access to this URI.

The generator 310 informs the guest OS controller 306 of that the generating of the delivery preparation information has been completed, and transmits the generated guest OS preparation information and the vehicle preparation information to the guest OS controller 306.

The execution information storage 322 stores the guest OS executing image serving as an image for executing the guest OS that delivers each firmware and the network setting information corresponding thereto as a file in advance. The guest OS controller 306 selects the guest OS executing image according to the firmware to be delivered and the network setting information corresponding to the guest OS executing image, and further holds the guest OS preparation information generated by the generator 310 in the execution information storage 322 as a file.

For example, the information is managed by an ID in which an ID of the AP 100 is combined with an ID of the guest OS. For example, the ID of the guest OS is generated based on a manufacturer, a vehicle type, a firmware type, a firmware version, and the like. The guest OS controller 306 generates the execution information acquisition destination information. The execution information acquisition destination information is a list of URIs for requesting the generated execution information from the AP 100. When the data acquisition request on this URI is received by the execution information deliverer 307, the execution information deliverer 307 transmits the selected guest OS executing image, the network setting information, and the previously generated guest OS preparation information to the selected AP 100. When the delivery process ends, the file of the guest OS preparation information is deleted from the execution information storage 322.

When the process ends, the guest OS controller 306 instructs the connection information transmitter 305 to transmit the connection information including the instruction information, the vehicle preparation information, the authentication information, the network setting information, and the position information of the AP 100 through the communication controller 302 and the communication unit 301, and thus the connection information is transmitted to the vehicle 200 (step S205).

Then, the guest OS controller 306 performs a connection to each AP 100 according to the HTTPS, and performs the server authentication and the client authentication. Thereafter, the guest OS controller 306 transmits the execution information acquisition destination information to the execution controller 734 of the AP 100, causes the execution information transceiver 733 of the AP 100 to download the execution information, and causes the executor 731 of the AP 100 to execute the guest OS. When the execution process of the guest OS is completed, the execution controller 734 of the AP 100 transmits a process completion notification indicating that the guest OS execution process has been completed.

Upon receiving the process completion notification, the guest OS controller 306 of the server 300 records transition to the activation state and a stop time of the guest OS in the state storage 323 (step S206). When there is already an entry, the guest OS controller 306 preferentially writes data that is long in a time of up to the stop time. For example, a value that is twice as large as a time to an expected time of arrival may be set as the stop time. When the stop time comes, the guest OS controller 306 instructs the guest OS execution controller 734 of the AP 100 to stop. The state storage may store, for example, an IP address of an AP in which the guest OS is operating. As described above, the guest OS preparation information and the vehicle preparation information may include the acquisition destination such as the URI or may have a form in which information itself is included.

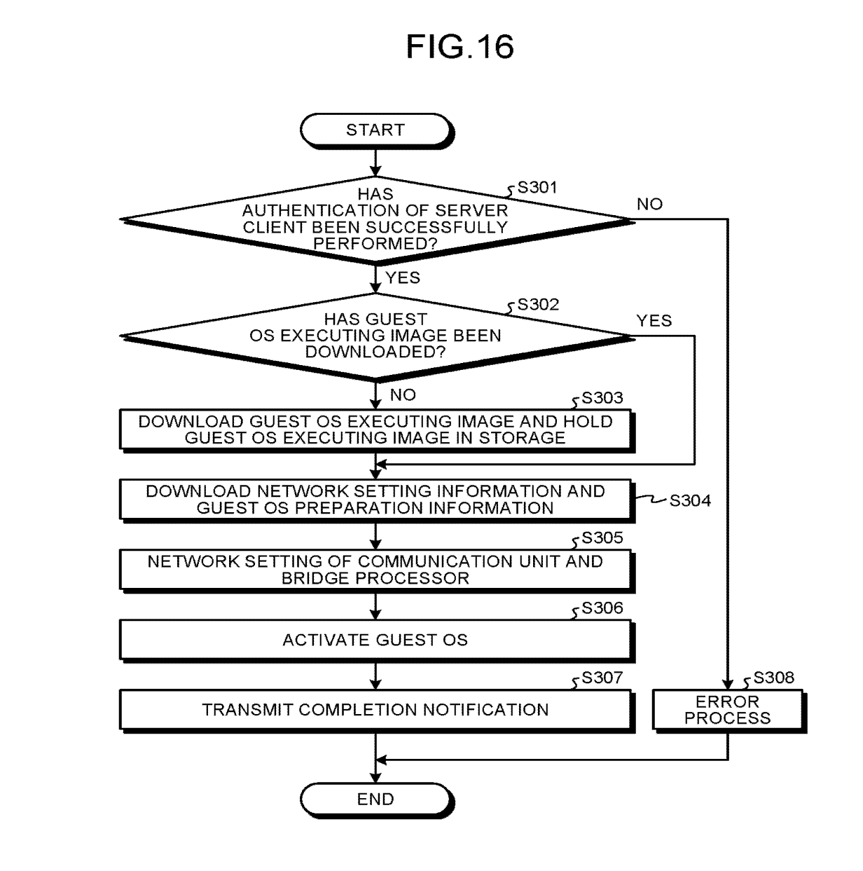

Next, a process of receiving the execution information acquisition destination information from the guest OS controller 306 of the server 300 and activating the guest OS in the AP 100 will be described. FIG. 16 is a flowchart illustrating an example of this process.

When communication with the execution controller 734 is established from the guest OS controller 306 of the server 300 through the communication unit 702, the authentication processor 736 performs the server authentication and the client authentication, and then the execution information acquisition destination information is transmitted from the guest OS controller 306 of the server 300. The execution controller 734 receives the execution information acquisition destination information, and notifies the execution information transceiver 733 of the execution information acquisition destination information.

In order to download of the files of the guest OS executing image, the network setting information, and the guest OS preparation information, the execution information transceiver 733 establishes communication with the execution information deliverer of the server 300 through the communication unit 702 according to the URI described in the execution information acquisition destination information, and determines whether or not the authentication has been successfully performed (step S301). The authentication process performed by the authentication processor 736 is performed based on the authentication information that is stored in the storage 751 or the like in advance.

When the authentication has failed (No in step S301), the authentication processor 736 performs an error process (step S308), and then the process ends.

When the authentication has been successfully performed (Yes in step S301), the execution information transceiver 733 determines whether or not the guest OS executing image has been already downloaded in the storage 751 (step S302). When the guest OS executing image has been already downloaded (Yes in step S302), the execution information transceiver 733 does not download the file. When the guest OS executing image has not been already downloaded (No in step S302), the execution information transceiver 733 downloads the guest OS executing image, and stores the guest OS executing image in the storage 751 through the storage controller 735 (step S303). The execution information transceiver 733 downloads the network setting information and the guest OS preparation information, and stores the network setting information and the guest OS preparation information in the storage 751 through the storage controller 735 (step S304).

When all the files have been completely downloaded, the execution information transceiver 733 reads the downloaded network setting information from the storage 751, and instructs the setter 716 to perform a setting based on the network setting information.

The wireless LAN adapter used by the communication unit 701 has a function capable of setting an ESSID for each VLAN. The setter 716 searches for a VLAN ID that is not in use for the communication unit 701, and creates the virtual communication unit (the virtual communication unit 801 in FIG. 9) serving as the virtual interface that is allocated the VLAN ID. Then, the setter 716 sets the ESSID and the security information designated by the network setting information to the interface (step S305).

Further, when the wireless LAN adapter supports multiple BSSIDs, the BSSIDs that can be used by the wireless LAN adapter in advance may be used in order for each virtual communication unit 801. When the wireless LAN adapter can set an arbitrary BSSID, the server 300 may designate and use a BSSID included in the network setting information.

A frame having the tag (the VLAN tag) of the set VLAN ID is from the virtual communication unit 801 set as described above to the bridge processor 721. When the frame of the virtual communication unit 801 is transmitted from the bridge processor 721, the VLAN tag is added to the frame, and the resultant frame is transmitted.

The setter 716 creates a port having a function of removing the VLAN tag from the frame or adding the VLAN tag to the frame for the bridge processor 721 so that the guest OS that is activated later can be connected to the port. As a result, the guest OS can perform communication via a network that is independent of the virtual communication unit 801 without being conscious of the VLAN.

Further, when the ESSID set by the network setting information is already being used by the virtual communication unit 801, the VLAN ID being used by the virtual communication unit 801 may be acquired, the corresponding guest OS may be caused to belong to the VLAN port, and the wireless LAN network having the common ESSID may be shared. The setter 716 can generate a new communication unit based on a VPN using the communication unit 702 and create an independent communication path of the server 300 in the Internet and configure a further divided network through the VLAN or the VXLAN. The VLAN tag may be added to the new communication unit based on the VPN, and the resultant communication unit may be transmitted.

When the setting by the setter 716 ends, the network setting information of the guest OS is transferred from the execution information transceiver 733 to the execution controller 734. Each information included in the network setting information of the guest OS is set by the setter 908 when the guest OS is activated. The guest OS may execute the DNS server, provide the DNS to the vehicle 200, changes a record of the DNS of the server 300 in the DNS server, access the guest OS rather than the server 300, and designate the DNS server whose record has not changed to the DNS server of the guest OS. Thus, it is possible to perform data acquisition from the server 300 and data acquisition from the AP 100 based on the common data acquisition list.

When the process described until now is completed, the execution controller 734 designates information of the port of the bridge processor 721 created above by the network setting, the guest OS executing image file, the network information set to the guest OS, and the guest OS preparation information, and instructs the executor 731 to activate the guest OS (step S306). At this time, the setter 908 sets the IP address, the netmask, the prefix length, the DNS server, and the routing information to the virtual communication controller 831 and the virtual communication controller 901 according to the network setting information of the guest OS. Even when VPN information or VLAN information is transferred, the setter 908 performs a setting to the virtual communication controller 831, the virtual communication controller 901 herein. Further, when the address range used by the communication of the virtual communication controller 831 is included, the setter 908 performs a setting to the DHCP server or the RA server, and distributes information of the DHCP or the RA from the virtual communication controller 831 after the activation. Further, the setting to the DHCP or the RA may be performed without including the designation of the IP address or the like in the network setting information of the guest OS. The execution controller 734 notifies the guest OS controller 306 of the server 300 of completion of the process (step S307). For example, information may be transmitted by storing the guest OS preparation information in the storage 751 so that it is seen as a file of a name decided by the delivery application in advance from the guest OS, or the information may be transferred by any other method.

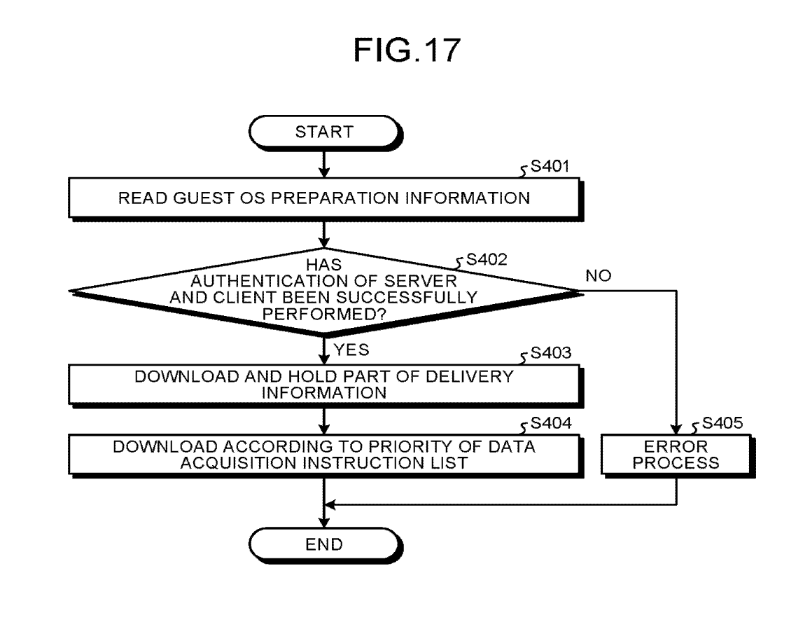

Next, a process of the delivery application after the guest OS is activated will be described. FIG. 17 is a flowchart illustrating an example of this process.

When the guest OS is activated, the delivery data processor 903 reads the guest OS preparation information instructed from the execution controller 734 (step S401). In order to download the delivery information for the guest OS from the server 300, the authentication processor 904 performs the server authentication and the client authentication, and determines whether or not the authentication has been successfully performed (step S402).

When the authentication process has failed (No in step S402), the authentication processor 904 performs the error process (step S405), and the process ends.

When the authentication process has been successfully performed (Yes in step S402), the delivery data processor 903 downloads and holds part of the delivery information for the guest OS according to the guest OS preparation information (step S403). Specifically, the delivery data processor 903 downloads the authentication information, the data acquisition list, the guest OS verification data, and the vehicle verification data according to the authentication information acquisition destination information, the data acquisition list acquisition destination information, the guest OS verification data acquisition destination information, and the vehicle verification data acquisition destination information included in the guest OS preparation information. The authentication information is stored in the cache storage through the memory controller 905. Other information is stored in the storage 751 through the virtual storage controller 907.

The delivery data processor 903 reads the upload destination information, the update state notification destination information, and the data acquisition status acquisition destination information included in the guest OS preparation information and content of the acquired data acquisition list, and recognizes a URI used at the time of uploading, a URI used at the time of the update state notification, a URI used at the time of data acquisition, and a URI used when the data acquisition status is acquired. Thereafter, when a request is received from the vehicle 200 or the AP 100, the delivery data processor 903 is set to be able to perform URI-based determination and execute a process according to the request. The authentication information and the guest OS verification data among the information is not delivered to the vehicle 200.

When the process described until now is completed, the guest OS enters a state in which data from the vehicle 200 and the delivery applications executed on the guest OS of another AP 100 is received. The delivery data processor 903 starts to download the chunk data of the firmware from the URI described in the data acquisition list based on the priority of the data acquisition instruction list included in the guest OS preparation information (step S404). A notification of the change in the cache state is given to the guest OS controller 306 of the server 300 each time the downloading is completed.

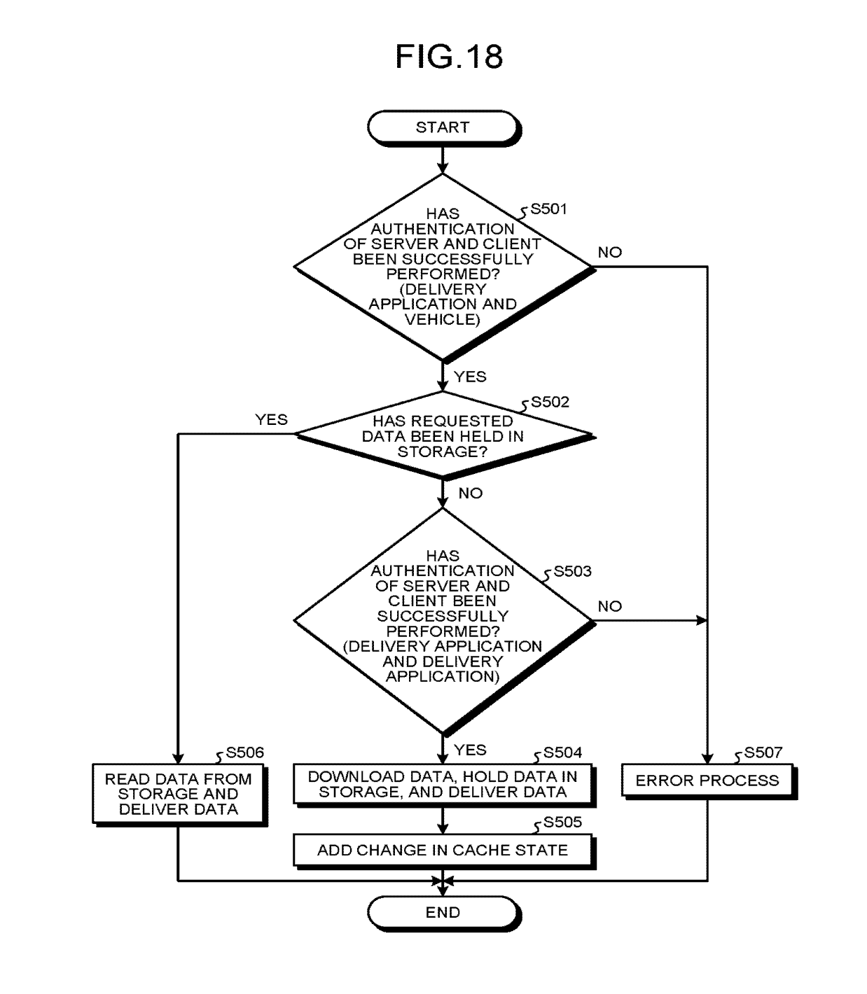

Next, a process when the delivery application operating on the guest OS of the AP 100 is requested to acquire (download) data from the vehicle 200 or another AP 100 will be described. FIG. 18 is a flowchart illustrating an example of this process.

The delivery data processor 903 receives a data acquisition request through the virtual communication controller 831 and the virtual communication controller 901. For example, the communication is performed using the HTTPS. The transmission of the data acquisition request to the delivery data processor 903 may be performed by the vehicle 200 through the virtual communication controller 831 or may be performed by the delivery application operating on the guest OS of another AP 100 through the virtual communication controller 901. When the data acquisition request is transmitted, the delivery data processor 903 receives the data acquisition request, and causes the authentication processor 904 to perform the server authentication and the client authentication.

The authentication processor 904 authenticates that they are a regular server (the delivery application) and a client (the vehicle) based on the certificate information stored in the cache storage or the storage 751, and determines whether or not the authentication has been successfully performed (step S501). When the authentication has failed (No in step S501), the delivery data processor 903 performs the error process (step S507), and the process ends.

When the authentication has been successfully performed (Yes in step S501), the delivery data processor 903 determines whether or not data requested to be acquired has been already stored or cached in the storage 751 (step S502). When data requested to be acquired has been already cached (Yes in step S502), the delivery data processor 903 reads data from the virtual storage controller 907, and delivers data to the request source through the virtual communication controller 831 or the virtual communication controller 901 (step S506).

When data requested to be acquired has not been already cached (No in step S502), the delivery data processor 903 is connected to the data deliverer 308 of the server 300 or the delivery data processor 903 of the delivery application operating on the guest OS of another AP 100 through the virtual communication controller 901, and the authentication is performed through the authentication processor 904. The authentication processor 904 authenticates that they are the regular server (the delivery application) and the client (the delivery application) based on the certificate information stored in the cache storage or the storage 751, and determines whether or not the authentication has been successfully performed (step S503). When the authentication has failed (No in step S503), the delivery data processor 903 performs the error process (step S507), and then the process ends.

When the authentication has been successfully performed (Yes in step S503), data is acquired from the data deliverer 308 of the server 300 or the delivery data processor 903 of the delivery application operating on the guest OS of another AP 100 and stored in the storage, and the acquired data is delivered (step S504). The delivery data processor 903 notifies the guest OS controller 306 of the server 300 of the change in the cache state through the virtual communication controller 901 (step S505).

As described above, the delivery data processor 903 can deliver the data acquisition list, the delivery data (the chunk data and the digital signature of the firmware or the like), and the vehicle verification data to the vehicle 200 and another AP 100. The guest OS verification data, the authentication information, the data acquisition instruction list that are used by only the guest OS are not delivered to the vehicle 200. Further, for example, the cached data is deleted based on a period of time set for each file by the server 300 or a determination by the delivery application. When data has been deleted, the delivery data processor 903 notifies the server 300 of the change in the cache state.

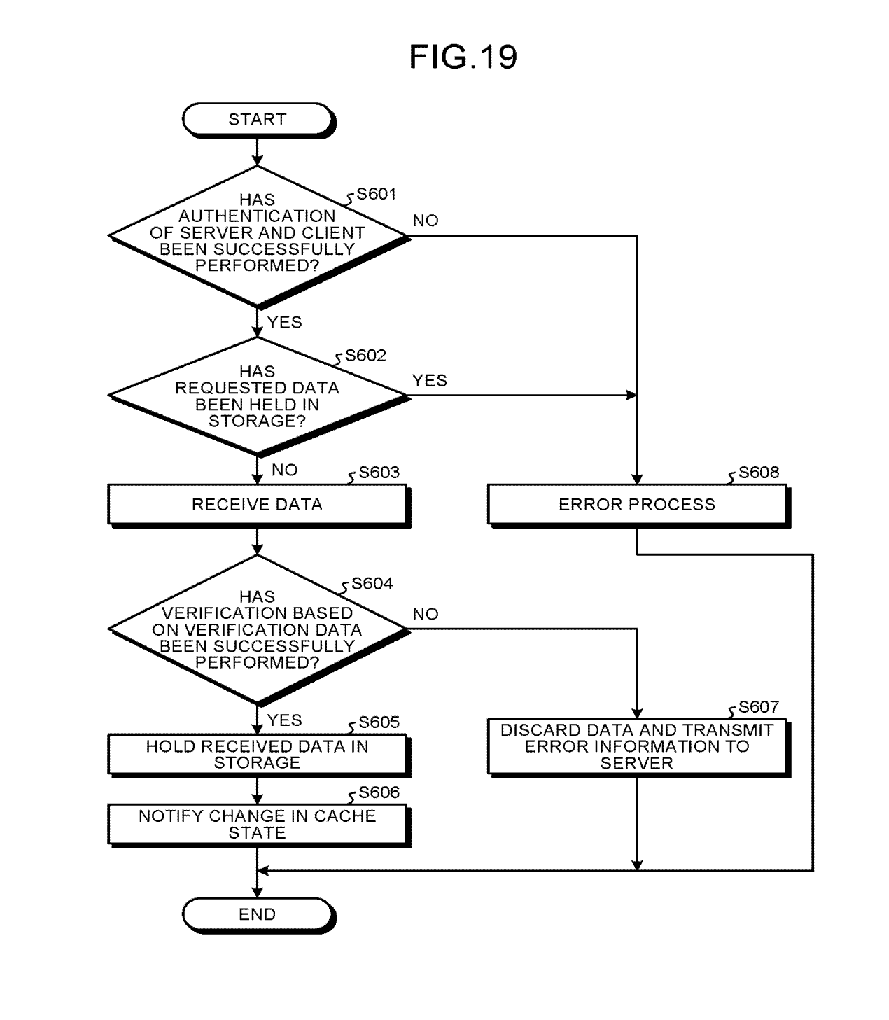

Next, a process when the delivery application operating on the guest OS of the AP 100 is requested to upload data from the vehicle 200 will be described. FIG. 19 is a flowchart illustrating an example of this process.

The delivery data processor 903 receives a data upload request through the virtual communication controller 831. For example, the communication is performed using the HTTPS. When the upload request is transmitted from the vehicle 200, the delivery data processor 903 receives the upload request, and causes the authentication processor 904 to perform the server authentication and the client authentication.

The authentication processor 904 authenticates that they are the regular server and the client based on the certificate information stored in the cache storage or the storage 751, and determines whether or not the authentication has been successfully performed (step S601). When the authentication has failed (No in step S601), the delivery data processor 903 performs the error process (step S608), and then the process ends.

When the authentication has been successfully performed (Yes in step S601), the delivery data processor 903 determines whether or not requested data has been already stored or cached in the storage 751 (step S602). When the requested data has been already cached (Yes in step S602), the delivery data processor 903 performs the error process (step S608), and then the process ends.

When the requested data has not been already cached (No in step S602), the delivery data processor 903 receives data to be uploaded from the vehicle 200 (step S603). The verifier 906 verifies the received data, and determines whether or not the verification has been successfully performed (step S604). For example, the verifier 906 reads the guest OS verification data stored in the storage 751, calculates a hash value of the received data, and determines whether or not the calculated hash value is identical to the hash value of the guest OS verification data. When the calculated hash value is not identical to the hash value of the guest OS verification data, that is, when the verification has failed (No in step S604), the delivery data processor 903 generates error information including the vehicle information, and transmits the error information to the server 300 through the virtual communication controller 901 (step S607).

When the calculated hash value is identical to the hash value of the guest OS verification data, that is, when the verification has been successfully performed (Yes in step S604), the delivery data processor 903 stores the received data in the storage 751 (step S605). The delivery data processor 903 notifies the guest OS controller 306 of the server 300 of the change in the cache state through the virtual communication controller 901 (step S606). As described above, the delivery data processor 903 can acquire the delivery data (the chunk data of the firmware) from the vehicle 200.

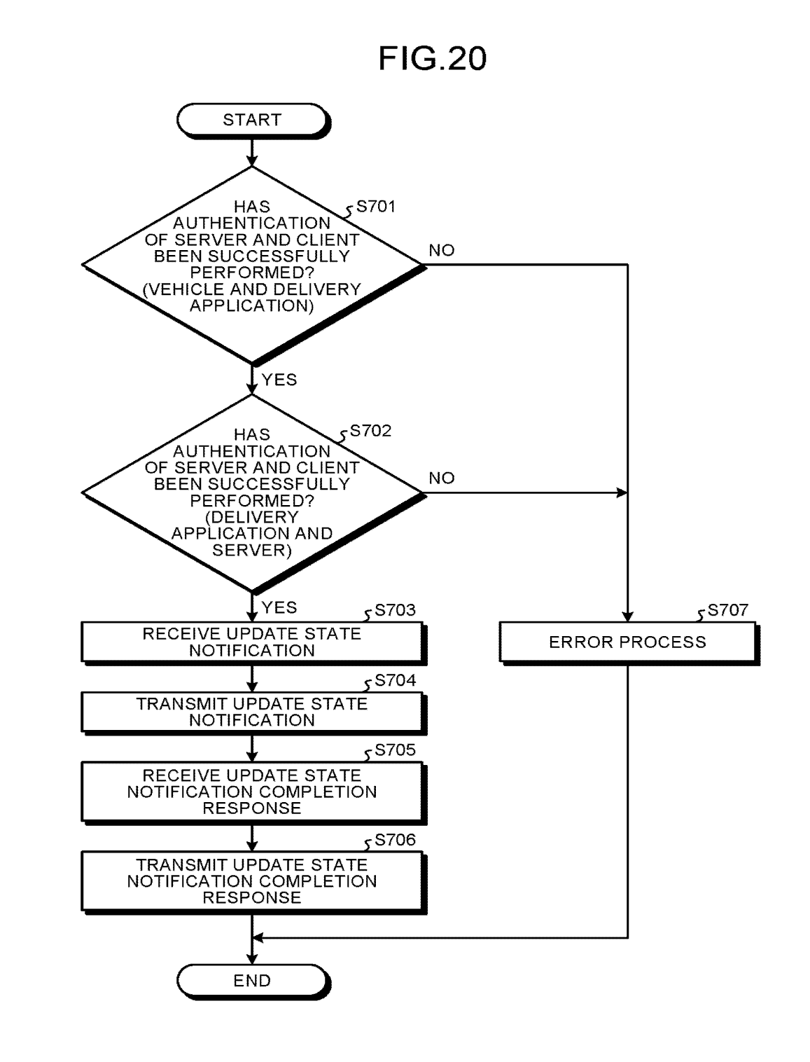

Next, a process when the delivery application operating on the guest OS of the AP 100 receives the update state notification from the vehicle 200 will be described. FIG. 20 is a flowchart illustrating an example of this process.

The state notifier 902 receives the update state notification from the vehicle 200 through the virtual communication controller 831. For example, the communication is performed using the HTTPS. When an update request notification is received from the vehicle 200, the delivery data processor 903 receives the update request notification, and causes the authentication processor 904 to perform the server authentication process and the client authentication process.

The authentication processor 904 authenticates that they are the regular server (the delivery application) and the client (the vehicle 200) based on the certificate information stored in the cache storage or the storage 751, and determines whether or not the authentication has been successfully performed (step S701). When the authentication has failed (No in step S701), the delivery data processor 903 performs the error process (step S707), and then the process ends.

When the authentication has been successfully performed (Yes in step S701), the state notifier 902 is connected with the notification processor 309 of the server 300. Then, the authentication processor 904 authenticates that they are the regular server (the server 300) and the client (the delivery application), and determines whether or not the authentication has been successfully performed (step S702). When the authentication has failed (No in step S702), the delivery data processor 903 performs the error process (step S707), and then the process ends.

When the authentication has been successfully performed (Yes in step S702), the state notifier 902 receives the update state notification transmitted from the vehicle 200 through the virtual communication controller 831 (step S703), and transmits the received update state notification to the notification processor 309 of the server 300 through the virtual communication controller 901 (step S704). Upon receiving an update state notification completion response from the notification processor 309 of the server 300 through the virtual communication controller 901 (step S705), the state notifier 902 transmits the received update state notification completion response to the vehicle 200 through the virtual communication controller 831 (step S706).

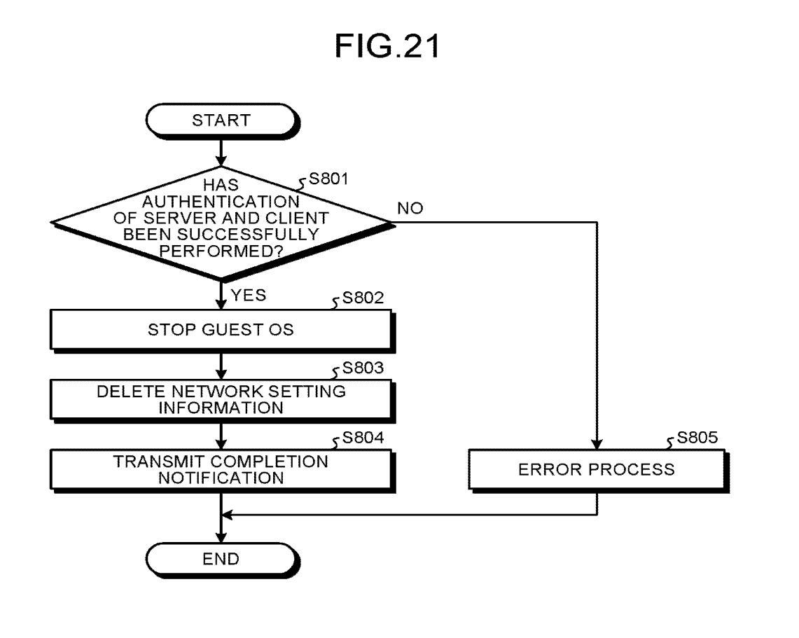

Next, a process when the execution controller 734 of the AP 100 receives a guest OS stop instruction from the server 300 will be described. FIG. 21 is a flowchart illustrating an example of this process.

Upon receiving the guest OS stop instruction from the guest OS controller 306 of the server 300 through the communication unit 702, the authentication processor 904 authenticates that they are the regular server and the client, and determines whether or not the authentication has been successfully performed (step S801). When the authentication has failed (No in step S801), the execution controller 734 performs the error process (step S805), and then the process ends.

When the authentication has been successfully performed (Yes in step S801), the execution controller 734 instructs the executor 731 to stop the guest OS (step S802). Then, the execution controller 734 reads the network setting information stored in the storage 751, and deletes information such as the ESSID and the VLAN of the communication unit 701 and the bridge processor 721 set when the guest OS is created (step S803). When the process is completed, the execution controller 734 notifies the guest OS controller 306 of the server 300 of completion of the process through the communication unit 702 (step S804). Further, the guest OS executing image and the network setting information are not immediately deleted but managed by another policy in the AP 100. For example, the guest OS executing image and the network setting information may be deleted when a non-access period of time is a predetermined value or more or may be deleted starting from the oldest one when the capacity of the information is a predetermined value or more.

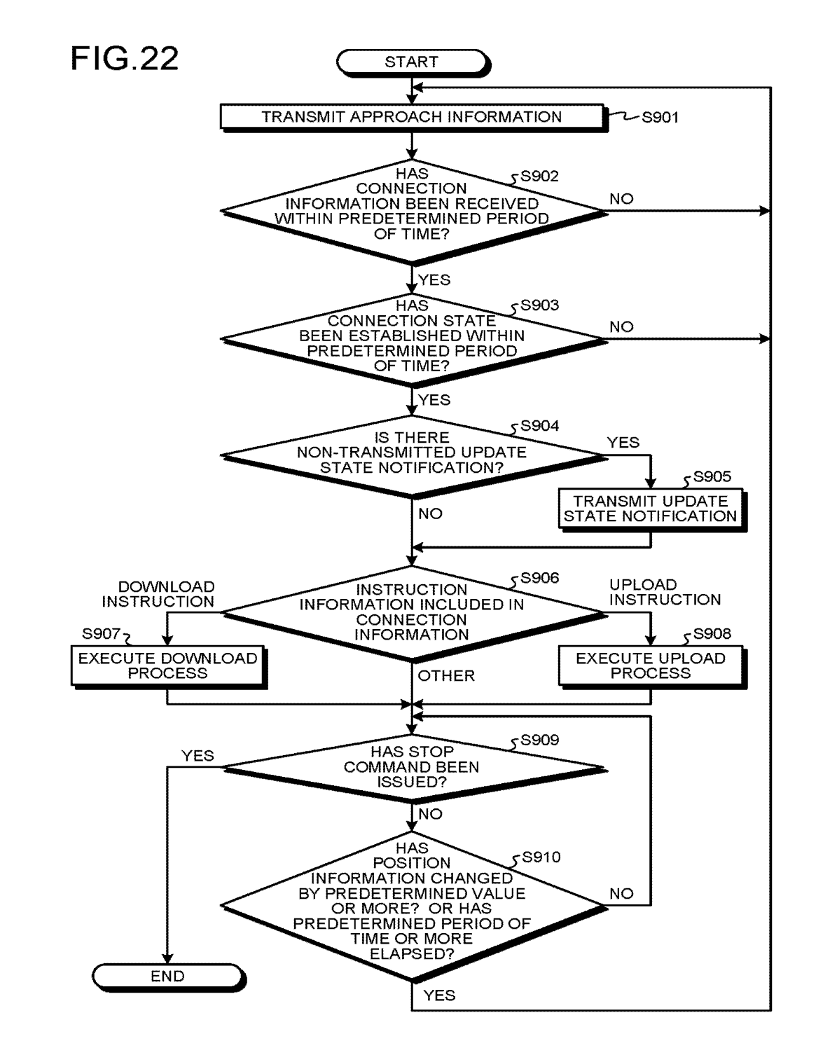

Next, a process in the vehicle 200 will be described. FIG. 22 is a flowchart illustrating a process executed by the vehicle 200.

When the vehicle 200 starts up as the ignition key enters the ON state, the transmitter 1114 transmits the approach information through the communication unit 1102 (step S901). The transmitter 1114 transmits the vehicle information stored in the storage 1151, the position information acquired from the position information acquirer, and the route information generated by the car navigation system or the like according to the notification destination information such as the URI of the server 300 stored in the storage 1151 in advance.

When the approach information is generated and transmitted by the AP 100 instead of the vehicle 200, the notification destination information may be transmitted as data for generating the approach information. The server 300 that has received the approach information determines whether the vehicle 200 is the firmware download instruction target, the upload target, or the update state notification transmission operation target, and transmits the connection information when the vehicle 200 is the processing target.

The receiver 1115 of the vehicle 200 determines whether or not the connection information has been received by the communication unit 1102 within a predetermined period of time (for example, 15 seconds) (step S902). When the connection information has not been received within the predetermined period of time (No in step S902), the process returns to step S901, and the approach information is transmitted again.

When the connection information has been received within the predetermined period of time (Yes in step S902), the setter 1131 performs the network setting of the communication unit 1101 based on the network setting information included in the connection information.

For example, the network setting information includes the ESSID or the BSSID serving as the wireless LAN parameter, the security information of the WEP/WPA/WPA2, and the like. The setter 1131 sets the information to the communication unit 1101 so that a connection with the already activated AP 100 can be established. The network setting information may include the IP address, the netmask, the prefix length, the DNS server address, the routing information, and the like. In this case, the setter 1131 sets the information to the communication unit 1101, so that communication is performed. Further, when the information is not included, the setter 1131 may set the communication unit 1101, for example, using the information of the DHCP or the RA distributed from the AP 100. The network setting information may be fixed in advance without being included in the approach information.

The receiver 1115 decides permissible criteria of a moving distance and an elapsed time until passing through the selected AP 100 completely based on the AP information included in the connection information. For example, the moving distance is set to be as twice far as the distance to the farthest AP 100 among the selected APs 100. The elapsed time is set to be as twice large as a time required to arrive at the AP 100 which is estimated to be the last. Instead of using the AP information, for example, a predetermined time (for example, one minute) may be decided as the permissible criterion. The receiver 1115 determines whether or not the connection state with the AP 100 has been established by the communication unit 1101 within the decided permissible criterion (within the predetermined period of time) (step S903).

When the connection state has not been established within the predetermined period of time (No in step S903), the process returns to step S901, and the approach information is re-transmitted from the transmitter 1114. When the connection state has been established within the predetermined period of time (Yes in step S903), a notification of the connection state is given from the receiver 1115 to the state notifier 1127, and the state notifier 1127 determines whether there is a non-transmitted update state notification (step S904). When there is the non-transmitted update state notification (Yes in step S904), after the server authentication and the client authentication are performed by the authentication processor 1129, the state notifier 1127 transmits the non-transmitted update state notification to the server 300 (step S905), and receives the update state notification completion response from the server 300. The server certificate and the public key of the delivery application may be included in the firmware and delivered or may be included in the connection information and transmitted. The server certificate and the public key of the delivery application may be inserted in the storage 1151 in advance and shipped.

When there is no non-transmitted update state notification (No in step S904), or after the update state notification is transmitted in step S905, the receiver 1115 determines whether the instruction information included in the connection information is the download instruction, the upload instruction, and any other instruction, and notifies the delivery data processor 1122 of the determination result (step S906). When the instruction information is the download process instruction (step S906: download instruction), the delivery data processor 1122 executes the download process (step S907). When the instruction information is the upload process instruction (step S906: upload instruction), the delivery data processor 1122 executes the upload process (step S908). When the instruction information is any other instruction (step S906: Other), no process is executed.

The transmitter 1114 determines whether or not a stop command of the vehicle 200 has been issued, for example, as the ignition key enters the OFF state (step S909). When the stop command has been issued (Yes in step S909), the transmitter 1114 stops the operation, and the process ends. When the stop command has not been issued (No in step S909), the transmitter 1114 determines whether or not the position information of its own vehicle has changed by a predetermined value or more or whether or not the predetermined period of time or more has elapsed (step S910). When the position information has not changed by the predetermined value or more, and the predetermined period of time or more has not elapsed (No in step S910), the process returns to step S909, and the process is repeated. When the position information has changed by the predetermined value or more or the predetermined period of time or more has elapsed (Yes in step S910), the process returns to step S901, and the approach information is transmitted again.

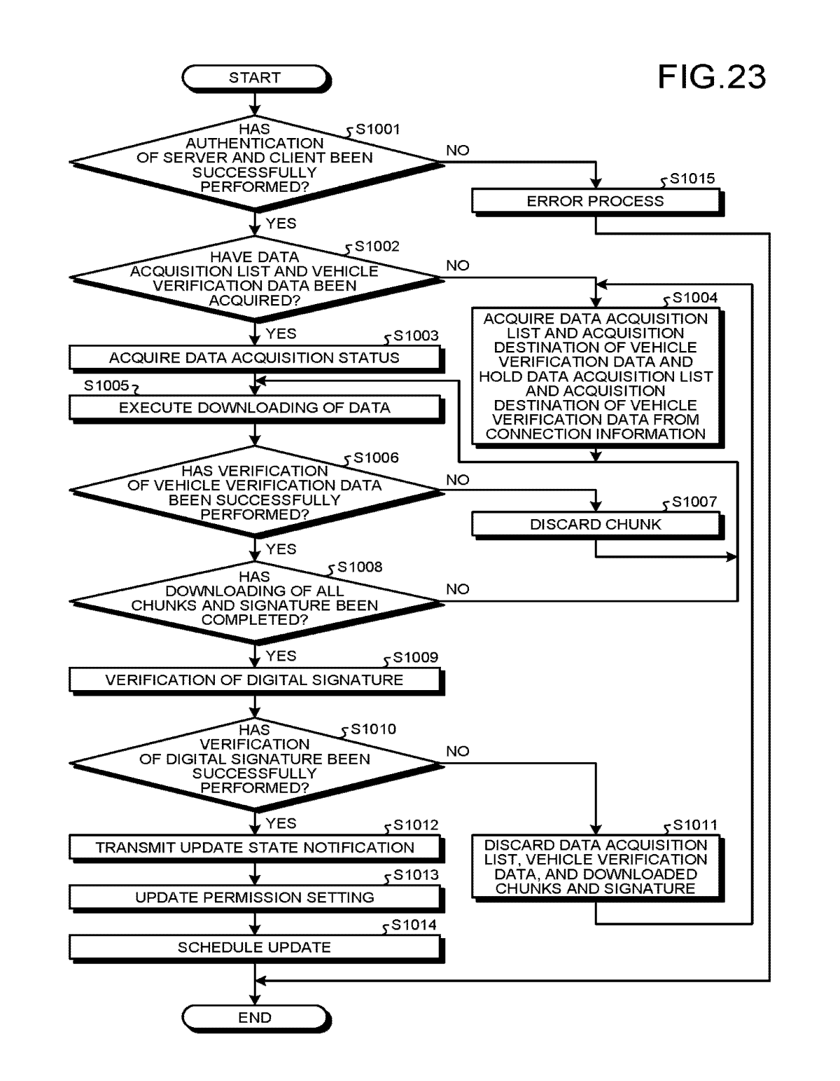

Next, a delivery data download process executed when the vehicle 200 receives the download instruction will be described. FIG. 23 is a flowchart illustrating an exemplary delivery data download process.

The delivery data processor 1122 that has received the download instruction causes the authentication processor 1129 to execute the authentication process in order to transmit data to the delivery application operating on the guest OS of the AP 100 through the communication unit 1101. The authentication processor 1129 reads the authentication information from the storage 1151, performs the server authentication and the client authentication, and determines whether or not the authentication has been successfully performed (step S1001). When the authentication has failed (No in step S1001), the delivery data processor 1122 performs the error process (step S1015), and then the process ends.

When the authentication has been successfully performed (Yes in step S1001), the delivery data processor 1122 determines whether or not the data acquisition list and the vehicle verification data have been acquired based on the connection information (step S1002). When the data acquisition list and the vehicle verification data have not been acquired (No in step S1002), the delivery data processor 1122 accesses the URIs described in the data acquisition list acquisition destination information and the vehicle verification data acquisition destination information included in the vehicle preparation information of the connection information, acquires the data acquisition list and the vehicle verification data from the delivery application operating on the guest OS of the AP 100, and stores the data acquisition list and the vehicle verification data in the storage 1151 (step S1004).

For example, the URI for acquiring a chunk file and a digital signature of the firmware is described in the data acquisition list. For example, the hash value of each chunk data of the firmware is recorded in the vehicle verification data.

When the data acquisition list and the vehicle verification data have been acquired (Yes in step S1002), the delivery data processor 1122 accesses the URI described in the data acquisition status acquisition information, and acquires the data acquisition status (step S1003). For example, the data acquisition status is expressed by a bitmap, similarly to the downloaded data information of the approach information. Thus, it is possible to detect the chunk data and the signature of the firmware cached by the delivery application operating on the guest OS of the AP 100. The delivery data processor 1122 accesses the URI described in the data acquisition list so that the cached chunk data is preferentially processed, and downloads the chunk data and the digital signature of the firmware (step S1005).

The verifier 906 checks whether or not the hash value of the downloaded chunk data is identical to the hash value recorded in the vehicle verification data (step S1006). When the hash values are not identical (No in step S1006), the delivery data processor 1122 discards the chunk data (step S1007), and makes an attempt to download another cached file (step S1005). This process is performed on all the chunk data described in the data acquisition list. The data verification the verifier 906 may be executed together when written in the storage 1151.

When the hash values are identical (Yes in step S1006), the delivery data processor 1122 determines whether the downloading of all the chunk data and the digital signature has been completed (step S1008), and when the downloading has not been completed (No in step S1008), the process returns to step S1005, and the process is repeated.

When all data has been downloaded (Yes in step S1008), the signature verifier 1121 verifies the digital signature for the firmware data in which all the chunk data is combined based on the server certificate of the server 300 (step S1009). The signature verifier 1121 determines whether or not the digital signature has been verified (step S1010). When the verification of the digital signature has failed (No in step S1010), the chunk data or the digital signature file is considered to have been altered or broken, and thus the delivery data processor 1122 discards the data acquisition list, vehicle verification data, and all downloaded chunk data and digital signature (step S1011), and the process is repeated.

When the verification of the digital signature has been successfully performed, and no data has been altered or broken (Yes in step S1010), the delivery data processor 1122 instructs the state notifier 1127 to transmit the update state notification (step S1012). The notification destination of the update state notification is included in the update state notification destination information included in the vehicle preparation information of the connection information. The update state notification may be transmitted through the communication unit 1101 or may be transmitted through the communication unit 1102. The update state notification includes a manufacturer, a vehicle type, and a serial number of the vehicle 200, a type of each firmware, a download completion state, version information of firmware that is currently being executed, information of the number of update trials, and error information.

In the case of this flow, the state notifier 1127 gives a notification indicating that the download has been completed, but the update has not been performed yet. Further, when the update state notification is normally received by the transmission destination, an update information notification completion response is transmitted. Thus, the state notifier 1127 makes an attempt to transmit the update state notification until the update information notification completion response is received.

Then, the signature verifier 1121 instructs the permit setter 1124 to perform an update permission setting. The permit setter 1124 accesses the storage 1151, copies the firmware data whose signature has been verified to a specific region of the storage 1151, and sets a permission of updating by the update executor 1126 using the copied data (step S1013). The permit setter 1124 instructs the scheduler 1125 to set an update execution period of time (step S1014). For example, the scheduler 1125 displays information indicating that there is an update on a touch panel type monitor (not illustrated), and causes the user to designate a date and a time.

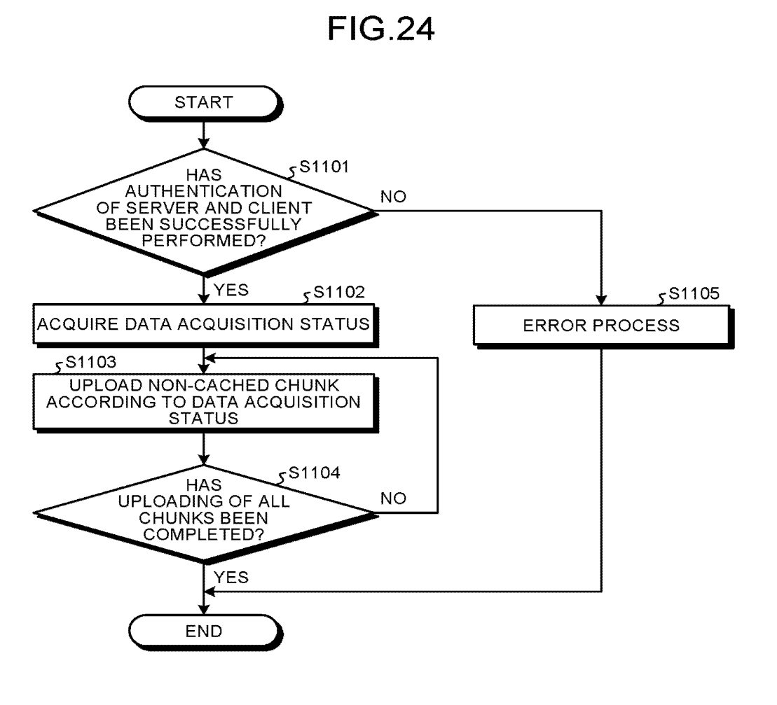

Next, a delivery data upload process executed when the vehicle 200 receives the upload instruction will be described. FIG. 24 is a flowchart illustrating an exemplary delivery data upload process.

The delivery data processor 1122 that has received the upload instruction causes the authentication processor 1129 to execute the authentication process in order to transmit data to the delivery application operating on the guest OS of the AP 100 through the communication unit 1101. The authentication processor 1129 reads the authentication information from the storage 1151, performs the server authentication and the client authentication, and determines whether or not the authentication has been successfully performed (step S1101). When the authentication has failed (No in step S1101), the delivery data processor 1122 performs the error process (step S1105), and then the process ends.

When the authentication has been successfully performed (Yes in step S1101), the delivery data processor 1122 accesses the URI described in the data acquisition status acquisition information, and acquires the data acquisition status (step S1102). As a result it is possible to detect chunk data of the firmware that is not cached by the delivery application operating on the guest OS of the AP 100. The delivery data processor 1122 accesses the URI included in the upload destination information and uploads the non-cached chunk data (step S1103). At this time, information indicating chunk data corresponding to a file to be uploaded may be transmitted as well. The delivery data processor 1122 determines whether or not all chunks have been completely uploaded (step S1104). When all chunks have not been completely uploaded (No in step S1104), the process returns to step S1103, and the process is repeated. When all chunks have been completely uploaded (Yes in step S1104), the process ends.

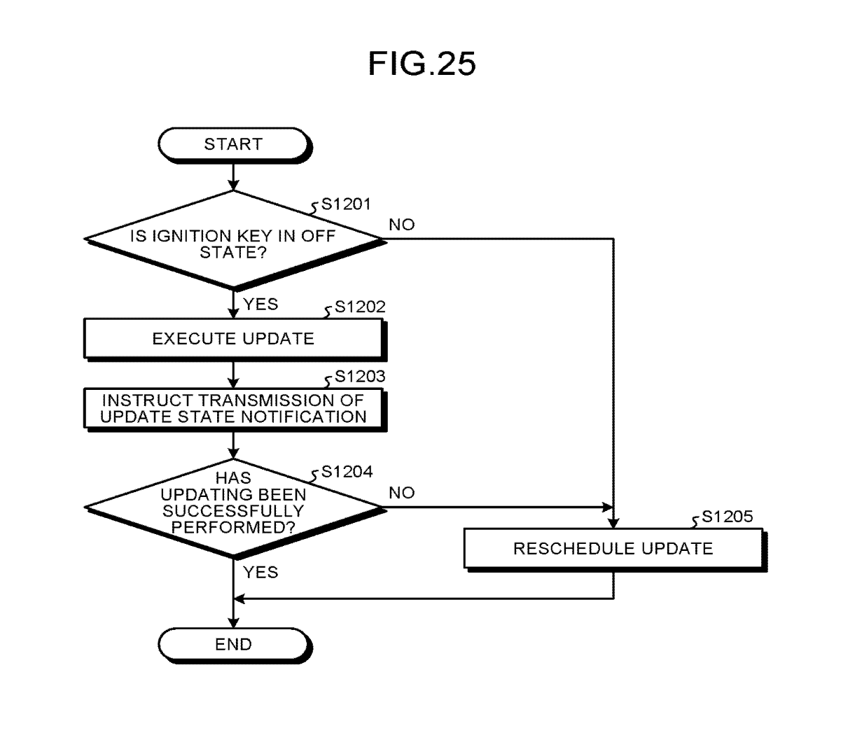

Next, an update process executed by the update executor 1126 when a time at which an update is scheduled comes will be described. FIG. 25 is a flowchart illustrating an exemplary update process.

The update executor 1126 causes the scheduler 1125 to start the process when a time at which the update process is scheduled comes. The update executor 1126 determines whether the ignition key enters the OFF state (step S1201). When the ignition key is in the ON state (No in step S1201), the update executor 1126 gives a notification to the scheduler 1125 so that the update process is rescheduled (step S1205).

When the ignition key is in the OFF state (Yes in step S1201), the update executor 1126 executes updating of the firmware (step S1202). For example, the update executor 1126 reads data from the storage 1151 through the storage controller 1128, and writes the data in a storage destination of the firmware to be updated. The update executor 1126 determines whether or not the updating has been successfully performed (step S1204). For example, when it is checked that the writing is completed, and the updated firmware normally operates, the updating is determined to have been successfully performed.

Then, regardless of whether or not the updating has been successfully performed, the update executor 1126 instructs the state notifier 1127 to transmit the update state notification when communication by the communication unit 1101 or the communication unit 1102 becomes possible (step S1203).

When the updating has been successfully performed (Yes in step S1204), the update process ends. When the updating has failed (No in step S1204), the update executor 1126 instructs the scheduler 1125 to reschedule (step S1205).

The vehicle 200 leaves a chunk file of the firmware corresponding to one version in order to upload data to the delivery application operating on the guest OS of the AP 100 later. The update state notification includes a download completion state, version information of firmware that is currently being executed, information about the number of update trials, and error information. When the updating has failed due to any reason, the server 300 can detect an abnormal state.

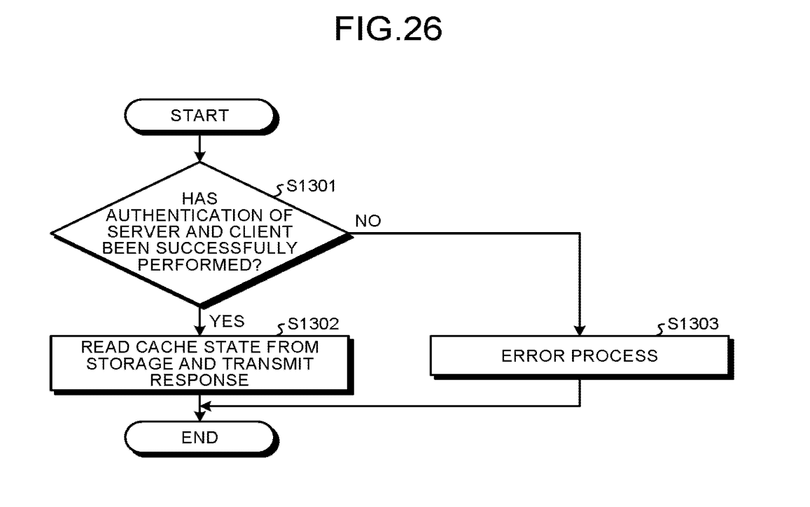

Next, a process when the delivery application is requested to acquire the data acquisition status from the vehicle 200 will be described. FIG. 26 is a flowchart illustrating an example of this process.

The delivery data processor 903 receives a data acquisition status acquisition request through the virtual communication controller 831. For example, the communication is performed using the HTTPS. When the data acquisition status acquisition request is transmitted from the vehicle 200, the delivery data processor 903 receives the data acquisition status acquisition request. The authentication processor 904 performs the server authentication and the client authentication, and determines whether or not the authentication has been successfully performed (step S1301). The authentication process by the authentication processor 904 is performed based on the authentication information that is previously stored in the cache storage, the storage 751, or the like.

When the authentication has failed (No in step S1301), the delivery data processor 903 performs the error process (step S1303), and then the process ends. When the authentication has been successfully performed (Yes in step S1301), the delivery data processor 903 reads the cache state from the storage 751, and transmits a response (step S1302). As described above, the delivery data processor 903 can transfer the data acquisition status to the vehicle 200.

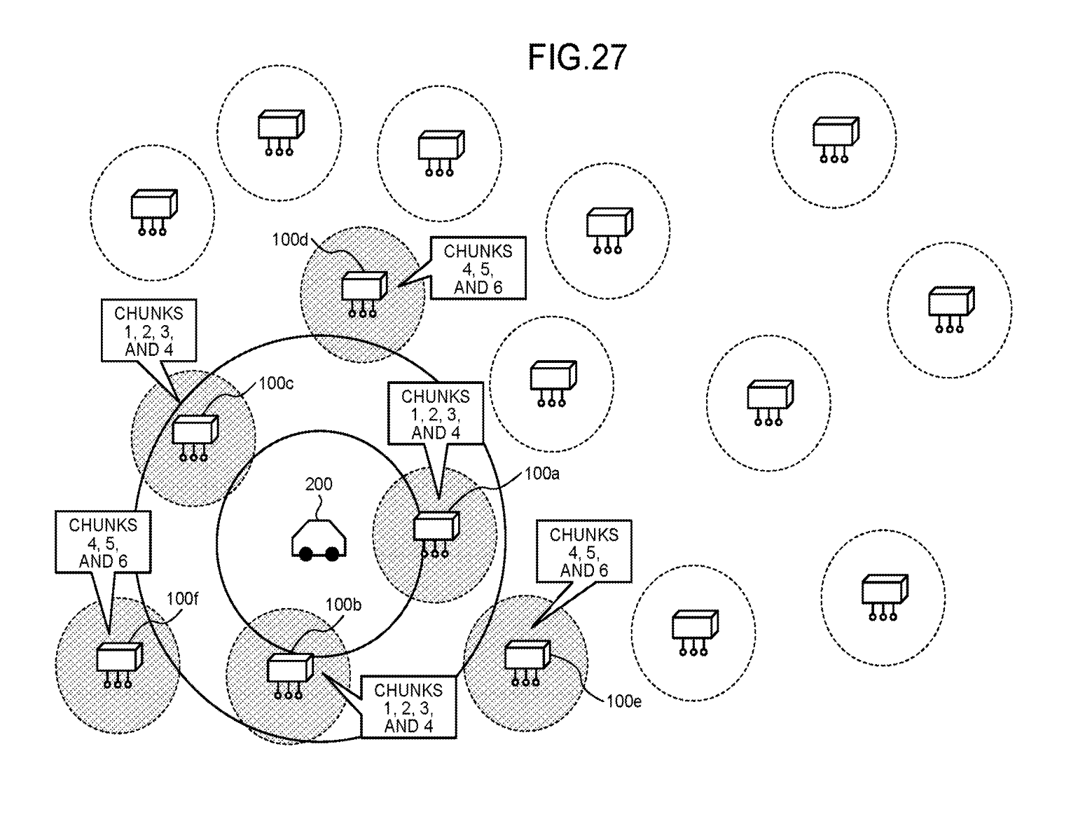

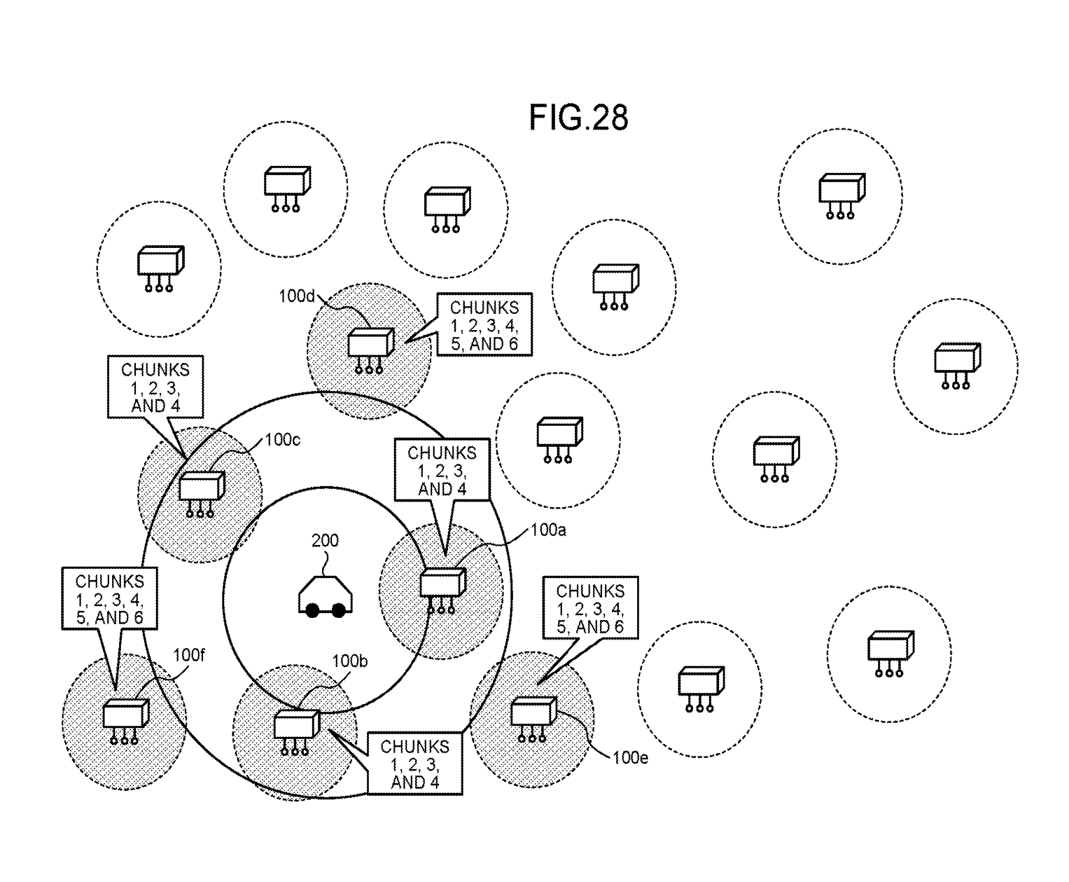

Next, a method of selecting the AP 100 serving as the acquisition destination of the delivery data will be described with reference to FIGS. 27 to 29. FIGS. 27 and 28 are diagrams for describing a method of selecting the acquisition destination without using the route information.

For example, the selector 304 selects the AP 100 included in a peripheral area centering on the vehicle 200 with reference to the approach information. For example, the selector 304 selects the AP 100 included in the delivery range in an area within a reference distance (for example, within the 10 km radius from the vehicle 200 as the AP 100 of the acquisition destination of the delivery data. A plurality of reference distances may be decided, and a delivery policy may differ according to each reference distance. For example, the AP 100 whose delivery range is included within the 5 km radius and the AP 100 whose delivery range is included within the 5 to 10 km radius may differ in chunk data to be delivered. This is implemented by creating and delivering a different data acquisition instruction list for each range.

At a location far from the position of the vehicle 200, chunk data expected to be delivered by the near AP 100 (APs 100a to 100c) may be excluded, and chunk data may be delivered. FIG. 27 illustrates example in which first to fourth pieces of chunk data are delivered through the APs 100a to 100c whose delivery range is included in an inner circle, and fourth to sixth pieces of chunk data are delivered through APs 100d to 100f whose delivery range is included in an outer circle. As described above, the duplicated chunk data (the fourth piece of chunk data in the example of FIG. 27) may be delivered in view of a non-reception possibility. A vehicle speed may be detected by a GPS, an acceleration sensor, a frequency change measurement by a Doppler effect, or the like, and the number of pieces of chunk data to be delivered may be decided according to the detected vehicle speed. Further, the data acquisition instruction list may be appropriately replaced with reference to information downloaded to the vehicle 200 each time the approach information is transmitted.

FIG. 28 illustrates example in which first to fourth pieces of chunk data are delivered through the APs 100a to 100c whose delivery range is included in an inner circle, and first to sixth pieces of chunk data are delivered through APs 100d to 100f whose delivery range is included in an outer circle. As a result, for example, even when it is difficult to establish a connection with the AP 100 close to the current position of the vehicle 200, it is possible to deliver data efficiently. Further, for example, even when a transmission rate of a network serving as a backbone is low, a possibility that acquisition of the chunk data from the server 300 by the AP 100 will be completed while the vehicle 200 is moving up to the AP 100 far from the current position is increased.

The method of selecting of the AP 100 is not limited to the above method. For example, the selector 304 may select one AP 100 expected to be highest in a possibility that data can be delivered rather than a plurality of APs 100.

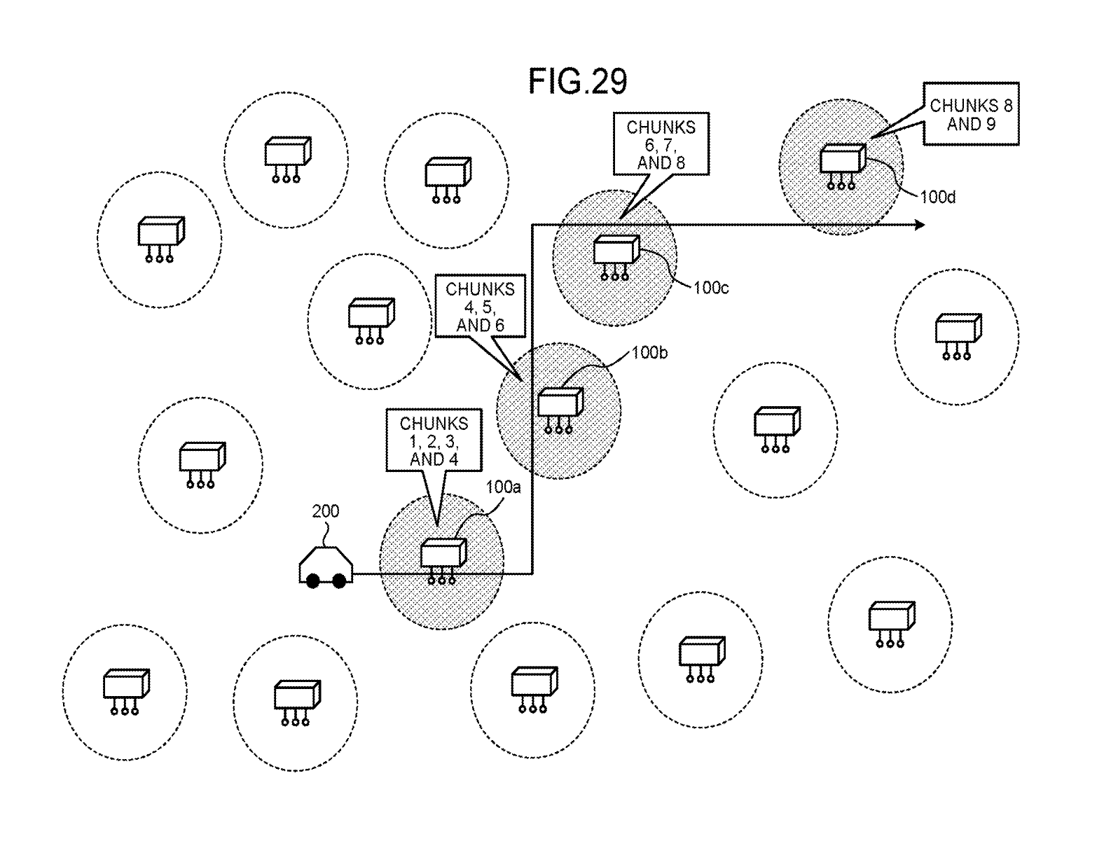

FIG. 29 is a diagram for describing a method of selecting the acquisition destination using the route information. The selector 304 may select the AP 100 whose delivery range is included in the route of the vehicle 200 with reference to the route information of the vehicle 200. The selector 304 may use speed information calculated by the car navigation system together with the route information. For example, the selector 304 decides a chunk to be delivered and the AP 100 to deliver the chunk together with an expected download amount calculated based on the route, the speed, and an expected arrival time of the vehicle 200 or a period of time in which communication can be performed. For example, the expected download amount may be calculated under the assumption that the maximum transfer capability of the AP 100 is all used by the vehicle 200.

FIG. 29 illustrates an example in which first to fourth pieces of chunk data, fourth to sixth pieces of chunk data, sixth to eighth pieces of chunk data, and eighth and ninth pieces of chunk data are delivered through APs 100a, 100b, 100c, and 100d installed along the route of the vehicle 200.

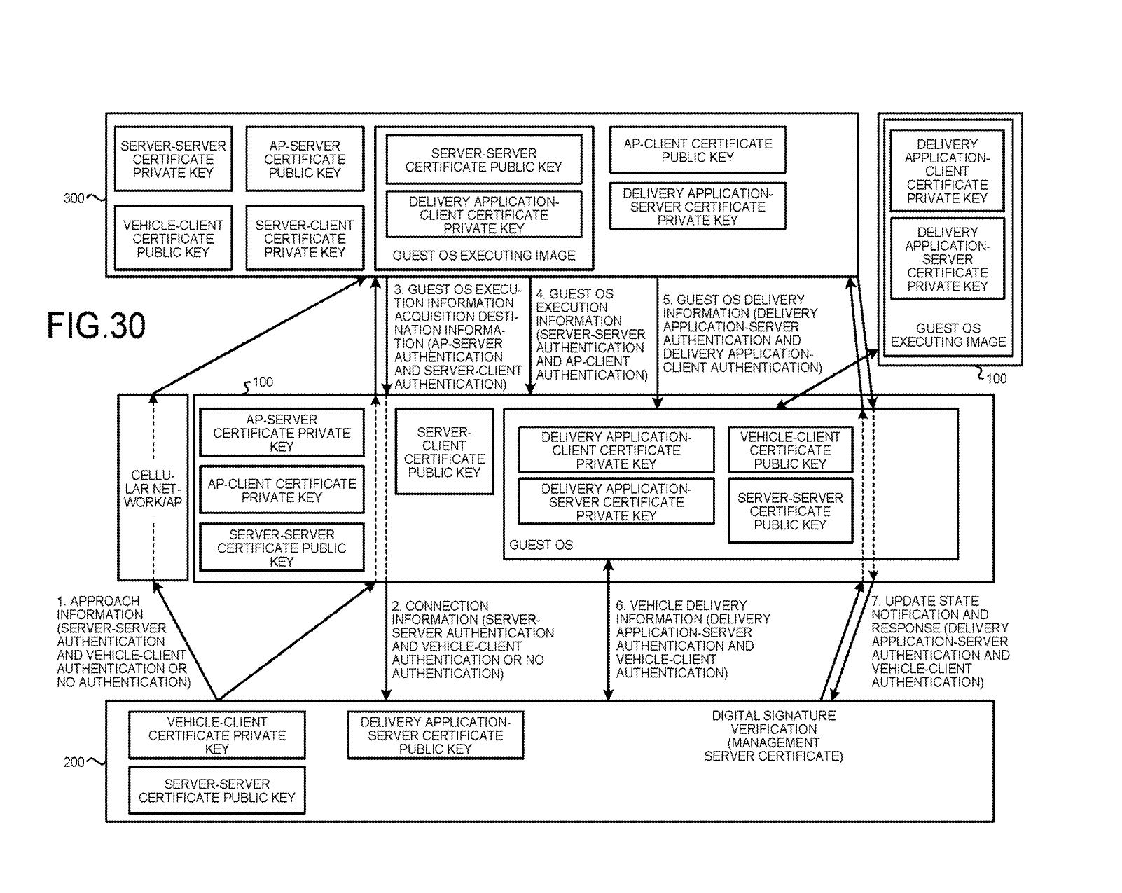

FIG. 30 is a diagram illustrating an authentication scheme applicable according to the present embodiment and exemplary information that is transmitted and received through the authentication process.

The AP 100, the vehicle 200, and the server 300 store the authentication information used in the authentication process with the other devices. For example, the server 300 stores a private key (a server-server certificate private key) of a server certificate used in the server authentication of the server 300 and a private key (a server-client certificate private key) of a client certificate used in the client authentication of the server 300.

In FIG. 30, an authentication scheme to be used is illustrated for each information transmitted and received between devices. For example, the approach information transmitted and received between the AP 100 and the vehicle 200 indicates whether or not the server authentication of the server 300 and the client authentication of the vehicle 200 are executed.

As a scheme of communication (for example, a notification of the approach information) that triggers the delivery process and a scheme of communication used for delivery of data, various combinations can be applied.

Exemplary combinations (pattern) of the triggering communication scheme and the communication scheme used for delivery will be described below.

### Pattern 1

triggering: cellular

delivery: IEEE802.11n/ac/ax

scheme necessary for vehicle: cellular,

IEEE802.11n/ac/ax

scheme necessary for AP: IEEE802.11n/ac/ax

cellular base station is necessary

### Pattern 2

triggering: IEEE802.11p (CCH)

delivery: IEEE802.11n/ac/ax

### Pattern 2-1

scheme necessary for vehicle: IEEE802.11p, IEEE802.11n/ac/ax

scheme necessary for AP: IEEE802.11p, IEEE802.11n/ac/ax

### Pattern 2-2

pattern including AP (AP-1) that supports dedicated

short range communications (DSRC) and AP (AP-2) that does not support DSRC

scheme necessary for vehicle: IEEE802.11p, IEEE802.11n/ac/ax

scheme necessary for AP-1: IEEE802.11n/ac/ax

scheme necessary for AP-2: IEEE802.11p

### Pattern 3

triggering: IEEE802.11p (CCH)

delivery: IEEE802.11p (SCH)

scheme necessary for vehicle: IEEE802.11p

scheme necessary for AP: IEEE802.11p

### Pattern 4

triggering: IEEE802.11n/ac/ax (for example, home or hot spot)

delivery: IEEE802.1n/ac/ax

scheme necessary for vehicle: IEEE802.11n/ac/ax

scheme necessary for AP: IEEE802.11n/ac/ax

The communication units of the AP 100 and the vehicle 200 described with reference to FIGS. 8 and 12 can be implemented by various combinations according to the above patterns. Exemplary combinations of the communication units will be described. For example, the communication units 701, 702, and 703 of the AP 100 can be configured by the following combinations.

### Pattern 1

Pattern 1-1
communication unit 701: IEEE802.11n/ac/ax
communication unit 702: cellular

Pattern 1-2
communication unit 701: IEEE802.11n/ac/ax
communication unit 702: Gigabit Ethernet

### Pattern 2

Pattern 2-1
communication unit 701: IEEE802.11n/ac/ax
communication unit 702: Gigabit Ethernet
communication unit 703: IEEE802.11p

Pattern 2-2
communication unit 701 of AP-1: IEEE802.11n/ac/ax
communication unit 702 of AP-1: the Gigabit Ethernet
communication unit 701 of AP-2: IEEE802.11p
communication unit 702 of AP-2: Gigabit Ethernet or cellular

### Pattern 3

communication unit 701: IEEE802.11p
communication unit 702: Gigabit Ethernet

### Pattern 4

communication unit 701: IEEE802.11n/ac/ax
communication unit 702: Gigabit Ethernet

For example, the communication units 1101 and 1102 of the vehicle 200 can be configured by the following combinations.

### Pattern 1

communication unit 1101: IEEE802.11n/ac/ax
communication unit 1102: cellular

### Pattern 2

communication unit 1101: IEEE802.11n/ac/ax
communication unit 1102: IEEE802.11p

### Pattern 3

communication unit 1101: IEEE802.11p
communication unit 1102: IEEE802.11p

### Pattern 4

communication unit 1101: IEEE802.11n/ac/ax
communication unit 1102: IEEE802.11n/ac/ax

For example, when communication is performed according to the scheme of IEEE801.11n/ac/ax, the AP operates in an infrastructure mode, the vehicle 200 operates as a station, and communication is performed by executing an association. When communication is performed according to according to the scheme of IEEE802.11p, combination between the vehicle 200 and the AP 100 is performed by communication defined by IEEE1609 using a wildcard BSSID without executing an association.

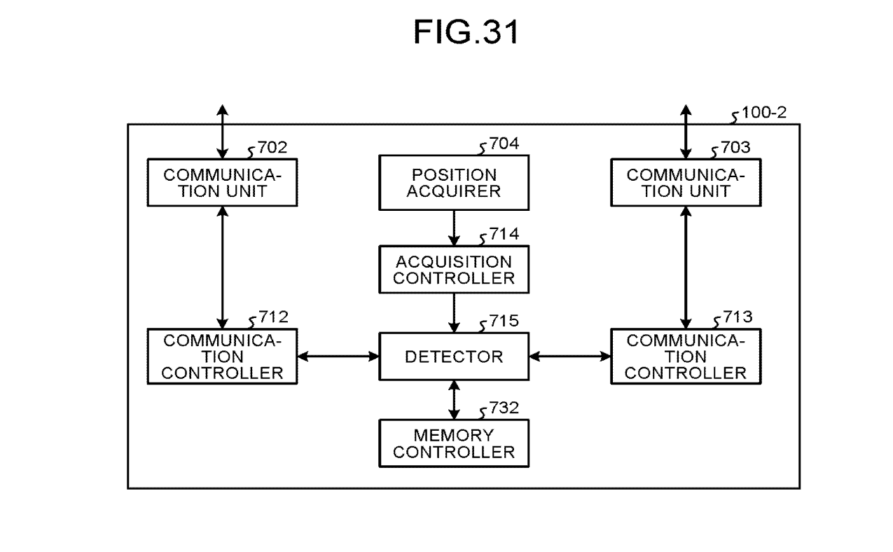

FIG. 31 is a block diagram illustrating an exemplary functional configuration of an AP 100-2 that performs, for example, transmission and reception of only the approach information and the connection information. The AP 100-2 includes communication units 702 and 703, a position acquirer 704, communication controllers 712 and 713, an acquisition controller 714, a detector 715, and a memory controller 732 as illustrated in FIG. 31. When the data delivery is not executed, a configuration in which the AP 100-2 is used can be provided.

The guest OS may be executed for each manufacturer as in the above example or may be executed for each vehicle type, each part, each producer of firmware, or each firmware version. In the above example, data of the firmware is divided into chunks having a fixed length, but, for example, a region of one file may be designated and downloaded, for example, using a range request of the HTTP.

The example in which the image for executing the guest OS, the network setting information, and the delivery information are delivered from the server 300 to the AP 100, and thereafter, the authentication information and the firmware are downloaded by the guest OS has been described above. The delivery method is not limited to this example, and, for example, the authentication information, the network setting information, and/or the delivery information for the guest OS may be included in the image for executing the guest OS and delivered together.

The exemplary firmware delivery has been described above, but the above-described technology can be applied to an example of delivery of content such as video, music, or the like. In this case, the firmware may be replaced with content, and the vehicle 200 may be replaced with a terminal device (for example, a smartphone) used by the user. In this case, the update state notification may be omitted.

The example in which the virtual environment (for example, the virtual machine of FIG. 2) and the virtual network (for example, the VLAN) are configured in a one-to-one manner, but both may be configured, for example, a many-to-many manner, a many-to-one manner, or a one-to-many manner.

The execution information and/or the delivery data may be acquired from another AP 100 (for example, a neighboring AP 100) instead of being transmitted from the server 300. This may be implemented by searching for the AP 100 holding (caching) data from the state storage 323 when the server 300 receives the acquisition request is received and redirecting the request. The cache state may be detected by a protocol in which the cache state is exchanged between the APs 100, and the detected cache state is redirected to another AP 100.

The position information may be acquired using a GPS installed in both the vehicle 200 and the AP 100. Only the vehicle 200 may be equipped with a GPS. In this case, GPS information of the vehicle 200 with which the AP 100 has performed communication may be acquired, and the position of the AP 100 may be estimated based on the GPS information. Further, the GPS information of the vehicle 200 may be transmitted to the server 300 or the AP 100 at the time of connection and disconnection with the AP 100. A configuration in which the position of the AP 100 is registered in a database of the server 300, and the database is referred to may be provided.

When the guest OS is executed, the guest OS may be executed in a state in which the guest OS executing image remains. For example, in a file system of unionfs (aufs) or the like, a change can be recorded in another file system in a state in which an original virtual machine image remains. Thus, since the original guest OS image remains, the virtual machine image can be delivered from the AP 100 to another device. Similarly, a method of using a data holding region as a separate image may be applied.

The position of the AP 100 need not be fixed, and a mobile AP 100 may be used. A traveling direction of the vehicle 200 may be considered in predicting movement of the vehicle 200.

In the above example, the transmission of the execution information acquisition destination information from the server 300 to the AP 100 and the acquisition of the execution information from the AP 100 to the server 300 are performed through different sessions, but they may be transmitted through the same session.

The wireless LAN parameter included in the network setting information included in the connection information or the guest OS execution information may include information defined in IEEE1609, information specific to an upper-level service, or the like when communication is performed according to IEEE802.11p in addition to the above example.

When the guest OS execution information and the delivery information for the guest OS are delivered from the server 300, the guest OS execution information and the delivery information for the guest OS may be delivered from the guest OS or the AP 100 rather than the server 300 by specifying the guest OS or the AP 100 holding the same data as requested data from the state storage 323 and redirecting the data.

Although not described in the above example, since communication between the AP 100 and the vehicle 200 may be disconnected in midstream, a time-out period of time is set to a transmission and reception process. For example, the time-out period of time may be set to 15 seconds, and the process may be stopped if no response is received during that period of time.

In the above example, the same data acquisition list is used for both the guest OS and the vehicle 200, but a list in which the acquisition destination of the guest OS is described may be generated for the vehicle 200, and a list in which the acquisition destination of the server 300 is described may be generated for the guest OS.

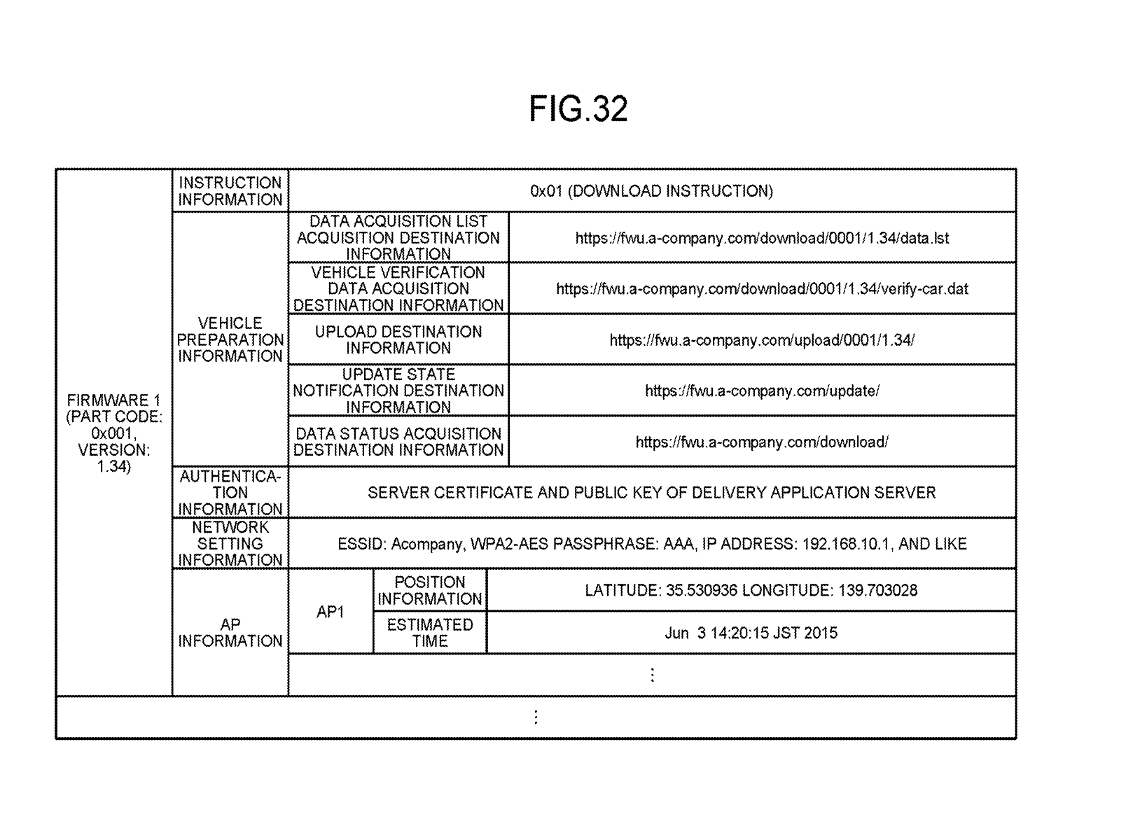

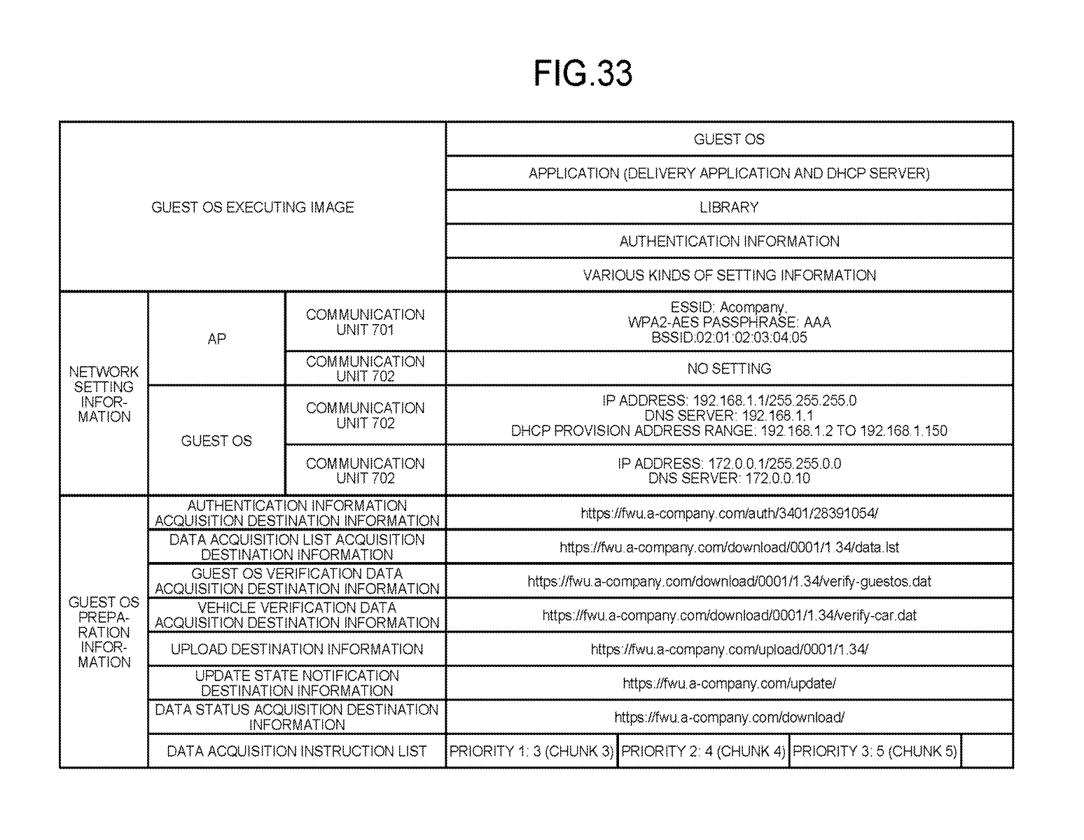

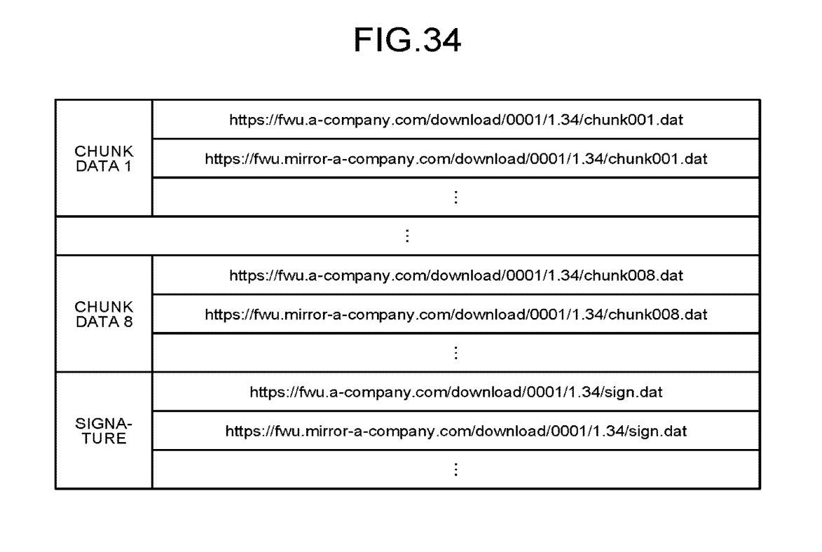

FIGS. 32 to 34 are diagrams illustrating exemplary data structures of the connection information, the execution information, and the data acquisition list. The data structures are examples, and any other data structure may be employed.

As described above, in the communication device according to the present embodiment, for example, the following functions can be implemented. (1) It is possible to isolate other programs executed by the roadside unit (AP) in units of virtual machines and further isolate a network. Thus, it is possible to implement various content delivery platforms without being limited to delivery of each firmware. (2) It is possible to guarantee that firmware is acquired in a correct route by performing an authentication. Further, since the authentication is performed together with the roadside unit rather than the delivery device (server), a time required for authentication can be reduced. (3) Execution of a partial code starts after the virtual machine is executed, and thus even when a rate of a backbone line is low, it is possible to rapidly start the delivery process partially.

The program executed by the communication device according to the present embodiment is embedded in the ROM 52, a storage, or the like and provided.

The program executed by the communication device according to the present embodiment may be configured to be recorded in a computer readable recording medium such as a compact disk read only memory (CD-ROM), a flexible disk (FD), a compact disk recordable (CD-R), or a digital versatile disk (DVD) as a file of an installable format or an executable format and provided as a computer program product.

Further, the program executed by the communication device according to the present embodiment may be configured to be stored in a computer connection to a network such as the Internet, downloaded via the network, and provided. Furthermore, the program executed by the communication device according to the present embodiment may be configured to be provided or distributed via a network such as the Internet.

The program executed by the communication device according to the present embodiment causes a computer to function as the respective units of the communication device. The computer can read the program from a computer readable storage medium onto a main storage device and executing the program through the CPU 51.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device that connects a terminal device with a server device, the device comprising:
a receiver configured to receive, from the server device, identification information for identifying a wireless network and program information for executing a program that performs wireless communication with the terminal device;
an execution controller configured to execute the program based on the program information; and
a setter configured to set the wireless network so that the program performs communication with the terminal device using the wireless network identified by the identification information.

2. The device according to claim 1, wherein the program has a function of receiving data from the server device and transmitting the received data to the terminal device.

3. The device according to claim 2, wherein the program receives the data from the server device so that the data having a higher priority designated from the server device is preferentially received.

4. The device according to claim 1, further comprising an authentication processor configured to authenticate the server device,
wherein the receiver receives the identification information and the program information from the server device when the server device is authenticated.

5. The device according to claim 1, wherein the program has a function of authenticating the terminal device, and performs communication with the terminal device when the terminal device is authenticated.

6. The device according to claim 1, wherein
the receiver receives, from the server device, first program information for executing a first program and second program information for executing a second program, and
the execution controller executes the first program and the second program in a virtual environment.

7. The device according to claim 1, wherein
the receiver receives, from the server device, first identification information for identifying a first wireless network and second identification information for identifying a second wireless network, and
the setter sets the first wireless network and the second wireless network as independent networks.

8. The device according to claim 1, wherein the program has a function of receiving data from the terminal device and storing the received data.

9. A communication system comprising:
a plurality of communication devices; and
a server device, wherein
the server device includes a deliverer configured to deliver identification information for identifying a wireless network and program information for executing a program by which the communication device and a terminal device perform wireless communication to a selected communication device among the plurality of communication devices, and
each of the communication devices includes
a receiver configured to receive the identification information and the program information from the server device,
an execution controller configured to execute the program based on the program information, and
a setter configured to set the wireless network so that the program performs communication with the terminal device using the wireless network identified by the identification information.

10. The system according to claim 9, wherein
the server device further includes a selector configured to select one of the plurality of communication devices based on position information of the terminal device, and
the deliverer transmits the identification information and the program information to the communication device selected by the selector.

11. A computer program product comprising a computer-readable medium containing a program executed by a computer that connects a terminal device with a server device, the program causing the computer to execute:
receiving identification information for identifying a wireless network and program information for executing a program that performs wireless communication with the terminal device from the server device;
executing the program based on the program information; and
setting the wireless network so that the program performs communication with the terminal device using the wireless network identified by the identification information.
